(19) United States
(12) Patent Application Publication
(10) Pub. No.: US 2011/0276831 A1
(43) Pub. Date: Nov. 10, 2011

(54) Utilizing Input/Output Paths For Failure Detection And Analysis

(75) Inventors: Itzhak Perelstein, Hoshaya (IL); Tal Doron, Haifa (IL); Benny Koren, Zikhron Ya'aqov (IL); Yedidia Atzmony, Omer (IL)

(73) Assignee: KAMINARIO TECHNOLOGIES LTD., Yokne'am ILIT (IL)

(21) Appl. No.: 13/101,414

(22) Filed: May 5, 2011

Related U.S. Application Data
(60) Provisional application No. 61/331,505, filed on May 5, 2010.

(51) Int. Cl. G06F 11/07

(52) U.S. Cl. 714/37; 714/E11.029

(57) ABSTRACT

Systems and methods for failure monitoring in a storage system. In some cases, a failed entity is detected based on an analysis of at least the indications obtained in return for input/output commands sent to multiple entities in the storage system. In some of these cases, it is also determined whether the failure is enduring or transient.

### FIELD OF THE INVENTION

The present invention relates to the field of storage.

### BACKGROUND OF THE INVENTION

In one configuration, an external host produces an input/output command and transmits the command to the storage system. If the command is properly executed, an indication of success is provided to the command producer. If a command is not properly executed, an indication of failure is instead provided to the host.

### SUMMARY OF THE INVENTION

According to some embodiments of the invention, there is provided a method of failure monitoring in a storage system, comprising: sending input/output commands to a plurality of entities in a storage system, and obtaining indications of results in return; and if there is at least one indication of failure result detected, then analyzing at least the obtained indications of results in order to determine a reason for the detected indication of failure result.

According to some embodiments of the invention, there is also provided a storage system comprising: a failure monitoring controller including: a command generator for generating and sending input/output commands to entities in the storage system; an indication obtainer for obtaining indications of results in return for the sent input/output commands, a failure result indication detector for detecting if there is at least one indication of failure result; and an analyzer for analyzing indications of results, if at least one indication of failure result has been detected, in order to determine a reason for the detected indication of failure result.

According to some embodiments of the invention, there is further provided an entity in a storage system comprising: a command receiver for receiving input/output commands originating from a host, and for receiving input/output commands originating from a failure monitoring controller; an origin detector for detecting that a received command originates from a failure monitoring controller and is a candidate for comparing; a command comparer for comparing the detected command with at least one previously handled command originating from a host to determine if similar or different; a command handler for handling the detected command if different, or for not handling the detected command if similar; and an indication returner for explicitly or implicitly returning an indication of result of the similar previously handled command originating from the host if similar, or for explicitly or implicitly returning an indication of result of the handled detected command if different.

According to some embodiments of the invention, there is still further provided a method of handling input/output commands in a storage system comprising: receiving an input/output command; detecting that the input output command originates from a failure monitoring controller and is a candidate for comparing; comparing the detected command with at least one previously handled command originating from a host to determine if similar or different; handling the detected command if different, or not handling the detected command if similar; and explicitly or implicitly returning an indication of result of the similar previously handled command originating from the host if similar, or explicitly or implicitly returning an indication of result of the handled detected command if different.

According to some embodiments of the invention, there is still further provided a computer readable medium having a computer readable code embodied therein for failure monitoring in a storage system, the computer readable code comprising instructions for: sending input/output commands to a plurality of entities in a storage system, and obtaining indications of results in return; and if there is at least one indication of failure result detected, then analyzing at least said obtained indications of results in order to determine a reason for said detected indication of failure result.

According to some embodiments of the invention, there is still further provided a computer readable medium having a computer readable code embodied therein for handling input/output commands in a storage system, the computer readable code comprising instructions for: (a) receiving an input/output command; (b) detecting that said input output command originates from a failure monitoring controller and is a candidate for comparing; (c) comparing said detected command with at least one previously handled command originating from a host to determine if similar or different; (d) handling said detected command if different, or not handling said detected command if similar; and (e) explicitly or implicitly returning an indication of result of said similar previously handled command originating from said host if similar, or explicitly or implicitly returning an indication of result of said handled detected command if different.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1A is a high level block diagram of an example of a storage system, according to some embodiments of the invention;

FIG. 1B is a high level block diagram of another example of a storage system, according to some embodiments of the invention;

FIG. 1C is a high level block diagram of another example of a storage system, according to some embodiments of the invention;

FIG. 2 is a more detailed block diagram of a failure monitoring controller in a storage system, according to some embodiments of the invention;

FIG. 3 is a more detailed block diagram of an entity in a storage system, according to some embodiments of the invention;

FIG. 4 is a flowchart illustration of a method of failure monitoring in a storage system, according to some embodiments of the invention;

FIG. 5 is a flowchart illustration of another method of failure monitoring in a storage system, according to some embodiments of the invention;

FIG. 6 (comprising FIGS. 6A and 6B) is a flowchart illustration of a method of analyzing failure in a storage system, according to some embodiments of the invention;

FIG. 7 is a flowchart illustration of a method of handling input/output commands by an entity in a storage system, according to some embodiments of the invention;

FIG. 8 is a high level block diagram of a storage system with a failed entity, according to some embodiments of the invention;

FIG. 9 is an illustration of an example analysis for detecting the failed entity of FIG. 8, according to some embodiments of the invention;

FIG. 10 is a block diagram of a failure monitoring controller divided into two or more units, according to some embodiments of the invention;

FIG. 11 is a flowchart illustration of a method performed by one type of failure monitoring controller unit, according to some embodiments of the invention;

FIG. 12 is a flowchart illustration of another method performed by one type of failure monitoring controller unit, according to some embodiments of the invention; and

FIG. 13 is a flowchart illustration of a method performed by another type of failure monitoring controller unit, according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures and components have not been described in detail so as not to obscure the present invention.

As used herein, the phrase “for example,” “such as”, “for instance” and variants thereof describe non-limiting embodiments of the present invention.

Reference in the specification to “one embodiment”, “an embodiment”, “some embodiments”, “another embodiment”, “other embodiments”, “one instance”, “some instances”, “one case”, “some cases”, “other cases” or variants thereof means that a particular feature, structure or characteristic described in connection with the embodiment(s) is included in at least one embodiment of the invention. Thus the appearance of the phrase “one embodiment”, “an embodiment”, “some embodiments”, “another embodiment”, “other embodiments” one instance”, “some instances”, “one case”, “some cases”, “other cases” or variants thereof does not necessarily refer to the same embodiment(s).

It should be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Unless specifically stated otherwise, as apparent from the following discussions, it is appreciated that throughout the specification discussions utilizing terms such as “sending”, “obtaining”, “analyzing”, “determining”, detecting”, “taking action”, “adding”, “retaining”, “noting”, “identifying”, “deciding”, “receiving”, “generating”, “transferring”, “providing”, “handling”, “returning”, “storing”, “performing”, “comparing”, or the like, refer to the action and/or processes of any combination of software, hardware and/or firmware. For example, these terms may refer in some cases to the action and/or processes of a computer or computing system, or similar electronic computing device, that manipulates and/or transforms data represented as physical, such as electronic quantities, within the computing system's registers and/or memories into other data similarly represented as physical quantities within the computing system's memories, registers or other such information storage, transmission or display devices.

Embodiments of the present invention may include apparatuses for performing the operations herein. Each of these apparatuses may be specially constructed for the desired purposes, or may comprise a general purpose computer selectively activated or reconfigured by a computer program stored in the computer. Such a computer program may be stored in a computer readable storage medium, such as, but not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not necessarily inherently related to any particular computer or other apparatus. Various general purpose systems may in some cases be used with programs in accordance with the teachings herein, or it may in other cases prove convenient to construct a more specialized apparatus to perform the desired method. Possible structures for a variety of these systems will appear from the description below. In addition, embodiments of the present invention are not described with reference to any particular programming language. It will be appreciated that a variety of programming languages may be used to implement the teachings of the inventions as described herein.

Throughout the description of the present invention, reference is made to the term “input/output command”, AKA “I/O command”, or simply to “command”. Unless explicitly stated otherwise, the term “I/O command”, “command”, or variants thereof shall be used to describe an instruction which refers to one or more storage segments. Typical types of I/O command include a read command that commands the retrieval of data that is stored within storage, and a write command that commands the storing of data within storage or the updating of existing data within storage. A read command is an example of a command which does not change the content in storage (“non-content changing command”) whereas a write command is an example of a command which changes the content in storage (“content changing command”). It would be appreciated, that many storage interface protocols include different variants on the I/O commands, but often such variants are essentially some form of the basic read and write commands. Examples of storage interface protocols include inter-alia: Small Computer System Interface (SCSi), Fibre Channel (FC), Fibre Channel over Ethernet (FCoE), Internet SCSI (iSCSI), Serial Attached SCSI (SAS), Enterprise System Connectivity (ESCON), Fibre Connectivity (FICON), Advance Technology, Attachment (ATA), Serial ATA (SATA), Parallel ATA (PATA), Fibre ATA (FATA), ATA over Ethernet (AoE). By way of example, the SCSI protocol will be referred to below even though other protocols may be used. The SCSI protocol supports read and write commands on different block sizes, but it also has variants such as the verify command which is defined to read data and then compare the data to an expected value. Further by way of example, the SCSI protocol supports a write-and-verify command which is effective for causing the storage of the data to which the command relates, the reading of the stored data, and the verification that the correct value was stored.

Embodiments of the current invention relate to storage systems. In the illustrated embodiments, a storage system includes a failure monitoring controller and at least two entities configured to handle input/output commands received from the failure monitoring controller or from one or more external hosts.

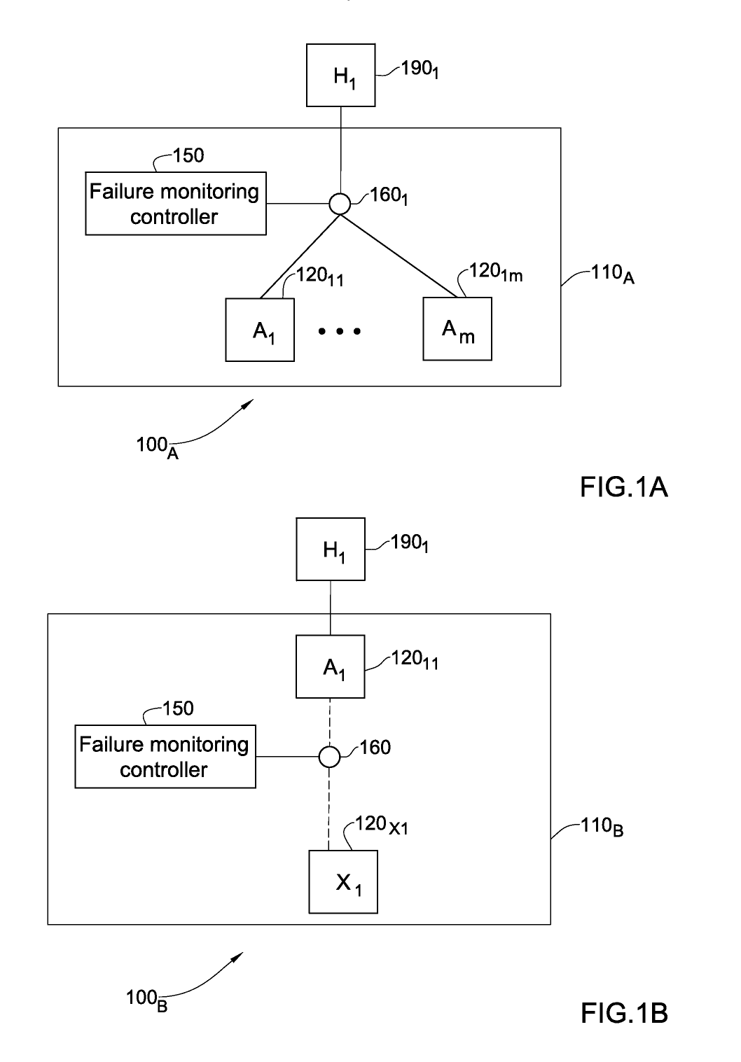

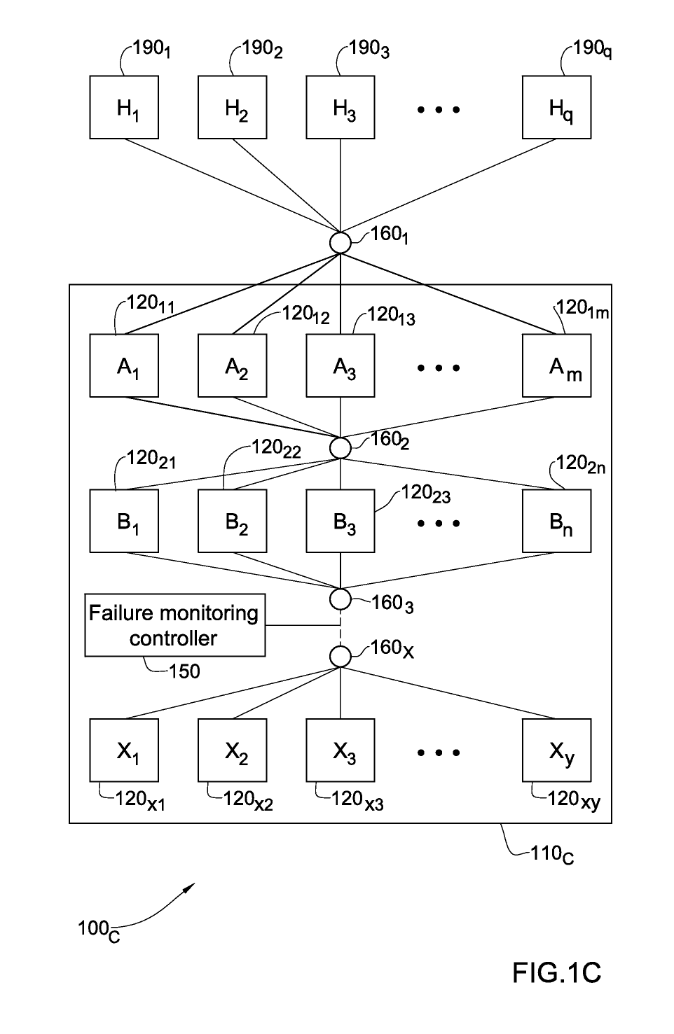

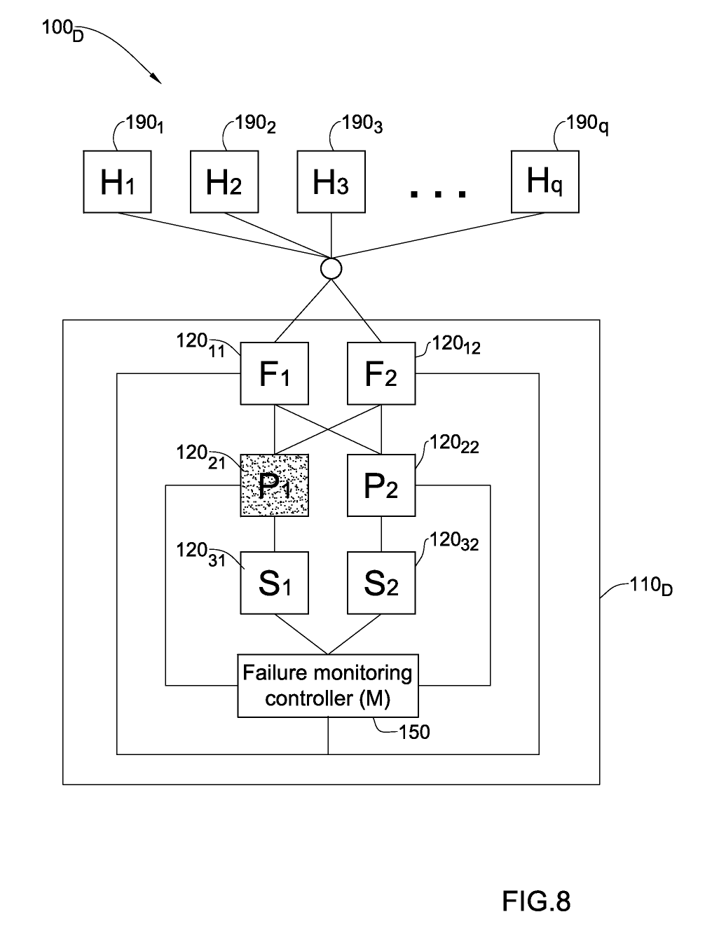

FIGS. 1A to 1C and FIG. 8 illustrate various examples of systems which include storage systems. These examples should not be construed as limiting. Herein below storage system 110 (without subscript) refers to any storage system which includes a failure monitoring controller and at least two entities configured to handle input/output commands received from the failure monitoring controller or from one or more external hosts. In contrast storage system 110_{subscript} (with a subscript) refers to a particular storage system illustrated in one of the figures. Similarly, system 100 (without a subscript) refers to any system that includes a storage system whereas system 100_{subscript} (with a subscript) refers to a particular system illustrated in one of the figures. Similarly host or hosts 190 (without a subscript) refer to any host(s) whereas host 190_{subscript} (with a subscript) refers to a particular host. Similarly entity or entities 120 (without a subscript) refers to any entity/ies. In contrast, entity 120_{subscript1 subscript2} refers to the subscript2^{th} entity at the subscript1^{th} level, so that entity 120₂₁ would refer to the first entity at the second level. This labeling is for convenience of the reader, as there is not necessarily any particular reason that one entity on the level should be labeled as the first and another entity as the second. In a storage system with levels, the levels may be physically differentiated or the levels may be logical with each entity aware of its own level. A command flows from an entity on a lower level to an entity on the next higher level, and the command acknowledgement flows back from the entity on the higher level to the entity on the next lower level. However, in other embodiments there is not necessarily a separation of entities 120 in storage system 110 into levels, but a command received by the storage system 110 may only flow once through any particular entity 120 in one direction. (Note that the command acknowledgement also flows back through the particular entity 120.)

FIG. 1A is a high level block diagram of a system 100_{A} which includes a storage system 110_{A} according to some embodiments of the invention. System 100_{A} includes a host 190₁ which generates I/O commands, and at least two entities A₁ 120₁₁ to Aₘ 120₁ₘ (m≧2) which receive and handle the commands. Entities A₁ 120₁₁ to Aₘ 120₁ₘ are at the same level in storage system 110_{A} and therefore commands are not transferred from one entity to the other in the illustrated embodiments. System 110_{A} also includes a failure monitoring controller 150 which will be described in more detail below. Although in the illustrated embodiments, each of host 190₁ and failure monitoring controller 150 is connected through a switch 160₁ to each entity A₁ 1201₁ to Aₘ 120₁ₘ, in other embodiments each of host 190₁ and failure monitoring controller 150 may be connected separately to each entity 120. Although only one host is illustrated in FIG. 1A in some embodiments there may be a plurality of hosts in system 100_{A}.

FIG. 1B is a high level block diagram of a system 100_{B} which includes a storage system 110_{B}. System 100_{B} includes a host 190₁ which generates I/O commands, and at least two entities A₁ 120₁₁ to X₁ 120_{X1} (where A represents a first level and X represents the Xth level with X≧2) which receive and handle the commands. Entities A₁ 120₁₁ to X₁ 120_{X1} are on different levels in storage system 110_{A} and therefore commands from host 190₁ are transferred from an entity on one level to an entity on the next deeper (higher) level beginning with entity A₁ 120₁₁. In some embodiments, the commands necessarily flow to the highest level X (to entity X₁ 120_{X1}), whereas in other embodiments a command may stop at any level. System 110_{B} also includes failure monitoring controller 150 which will be described in more detail below. Depending on the embodiment failure monitoring controller 150 may be connected to each entity A₁ 120₁₁ to X₁ 120_{X1} separately, or may be connected through one or more switches 160. Although only one host is illustrated in FIG. 1B in some embodiments there may be a plurality of hosts in system 100_{B}.

FIG. 1C is a high level block diagram of a system 100_{C} which includes a storage system 110_{C}. System 100_{C} includes a plurality of hosts 190₁ to 190_{q} (q≧1), a plurality of levels A to X (X≧2), and a plurality of entities. For example in the illustrated embodiments on level A there are m entities (m≧1), on level B there are n entities (n≧1), and on level X there are y entities (y≧1), with m, n and y not necessarily the same number. Entities on the same level in storage system 110_{C} do not transfer a command from a host 190 between one another. Entities on different levels in storage system 110_{C} do transfer to one another and therefore a command from a host 190 is transferred from an entity on a lower level to an entity on the next higher level beginning with an entity on the A (first, lowest) level. The command may travel until the Xth level or may stop at any lower level. In the illustrated embodiments, all possible paths from level A to level X (or to any lower level) are predetermined paths via which a command can be transferred. In some embodiments, not all possible paths between levels are predetermined paths via which a command can be transferred. These embodiments will be explained in more detail with reference to FIG. 8. For each predetermined path, an entity on a lower level may be separately connected to an entity on the next higher level, or a switch may enable all possible connections (for example switch 160₂ to 160ₓ (x≧1). In some cases, if no predetermined path passes through a certain entity 120, the entity is irrelevant and may be omitted from storage system 110_{c}. System 110_{c} also includes failure monitoring controller 150 which will be described in more detail below. Depending on the embodiment failure monitoring controller 150 may be connected to each entity 120 separately, or may be connected through one or more switches. Although FIG. 1C illustrates at least three levels, at least four entities per level, at least four hosts, and at least four switches, these values should not be construed as minimums for system 100_{C}. In some embodiments there may be fewer levels, fewer entities, fewer hosts and/or fewer switches.

The invention does not require a certain number and/or configuration of switch(es) in storage system 110_{c} and depending on the embodiment the number and/or configuration may vary. For example, in various embodiments, the switch(es) may include bridge hubs, the switches may be connected together as a star, or the switch(es) may be laid out in any appropriate configuration.

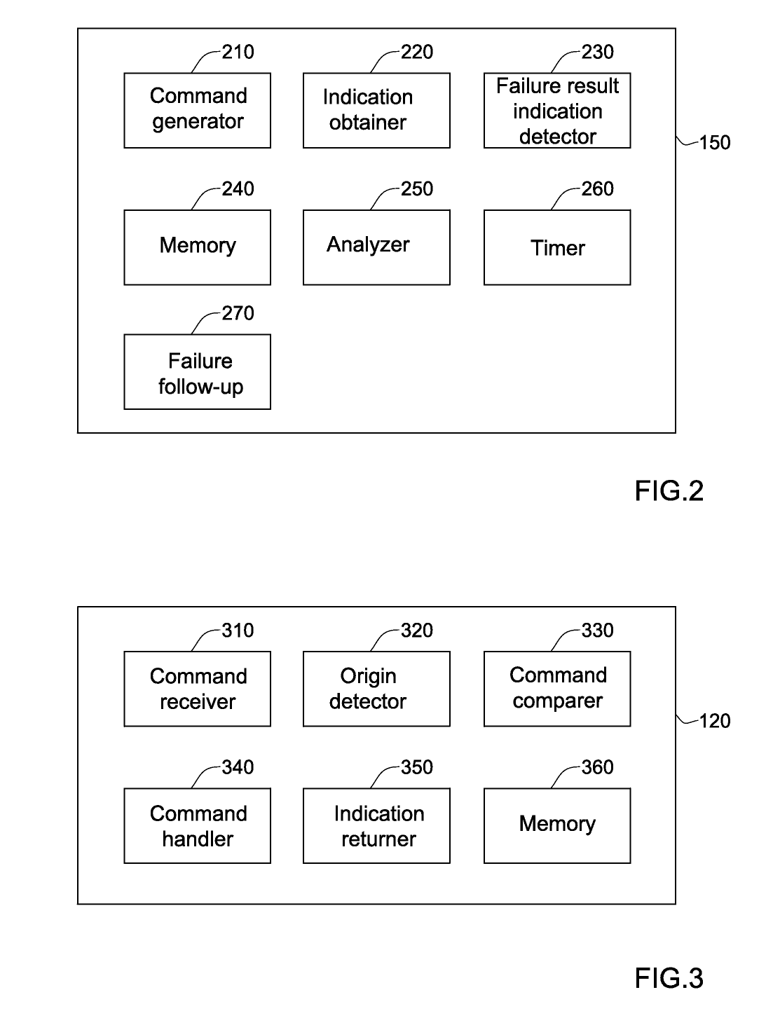

FIG. 2 is a block diagram illustration of failure monitoring controller 150, according to some embodiments of the present invention. In the illustrated embodiment, failure monitoring controller 150 includes an input/output command generator 210, an indication obtainer 220, a failure result indication detector 230, an analyzer 250, optionally a memory 240, optionally a timer 260 and optionally a failure follow-up module 270. Each of modules 210, 220, 230, 240, 250, 260 and/or 270 may be made up of any combination of software, hardware and/or firmware capable of performing the operations as defined and explained herein. In some embodiments, failure monitoring controller 150 may comprise fewer, more and/or different modules than illustrated in FIG. 2. In some embodiments, the functionality of failure monitoring controller 150 described herein may be divided differently among the modules shown in FIG. 2. In some embodiments, the functionality of controller 150 described herein may be divided into fewer, more and/or different modules than shown in FIG. 2. In some embodiments, controller 150 may include additional or less functionality than described herein. For example, in some cases controller 150 may include additional functionality unrelated to monitoring failure. In some embodiments, controller 150 may be divided into two or more controllers, which may possibly be dispersed geographically. For example, in some embodiments, controller 150 may be divided into two or more controller units and in some of these embodiments controller 150 or part of controller 150 may be replicated at each entity 120 or in proximity to each entity. For simplicity of description, unless explicitly stated otherwise, the single form of failure monitoring controller 150 is used below to include both embodiments with one failure monitoring controller unit 150 and embodiments with a plurality of failure monitoring controller units 150.

In the illustrated embodiments, input/output command generator 210 is configured to generate and send one or more rounds of input/output commands to entities 120 in storage system 110. For simplicity of description, it is assumed that two identical commands (i.e. which follow the same predetermined path) are sent in separate rounds by command generator 210 and therefore the boundary between rounds separates identical commands. Depending on the embodiment, input/output commands in the same round may or may not be sent simultaneously to receiving entities 120.

In some embodiments, each round of input/output commands sent by command generator 210 includes input/output commands corresponding to each predetermined path in storage system 110 and therefore assuming that at least one predetermined path passes through each entity 120 in storage system 110, at least one command is sent to each entity 120 in each round. (In some cases, an entity 120 through which no predetermined path passes may be considered irrelevant and may be ignored during the failure monitoring described herein) In some of these embodiments assuming entities are arranged on levels and in order to cover all predetermined paths, one command is sent to each entity 120 on the highest level of storage system 110, and the number of commands which are sent to a certain entity 120 which is not on the highest level of storage system 110 is determined based on the number of predetermined paths continuing from that entity. For example, if a certain entity 120 branches to two entities 120 on the next level, and each of these two entities 120 branches to three entities 120 on the final level, then in some cases six commands, each testing a different predetermined path would be sent to the certain entity 120. It is noted that in some cases a predetermined path may be a subpath of another predetermined path, where the subpath only includes entities on the other path but does not include all of the entities on the other path.

However in other embodiments a round of input/output commands sent by command generator 210 does not necessarily correspond to each predetermined path and/or a round of input/output commands may in some cases be sent to selective entities 120 in storage system 110. In these embodiments, the sent commands correspond only to predetermined paths for which indications of results are currently desired. Continuing with the example from above, in other cases of the example, if only three of these predetermined paths are suspect, for instance because an indication of success that was previously obtained involves the first of the two entities 120 on the middle level, then it is possible that only three commands testing these suspect paths (passing via the second entity on the middle level) may be sent to certain entity 120. A path would be considered a suspect path, for instance, if the path is a failing or potentially failing path. In another example, if enduring failure is interesting in a particular implementation, but not transient failure, and commands from previous round(s) corresponded to either indications of failures and successes, additional round(s) may only include those commands which corresponded to obtained indications of failure to see if the failure is enduring or not. In another example, if predetermined paths cross one-another and therefore optimization can be performed, then less commands may be sent than the number of predetermined paths. In another example, if controller 150 previously obtained an indication failure result for a command originating from the host for the same path, then command generator 210 may not necessarily generate a command for the same path. Continuing with the example, if the indication were instead success result, then in some cases command generator 210 may not necessarily generate one or more commands corresponding to the same path or to sub-paths of that path. In another example, there may be a motive to limit the number of commands sent to entities 120 so as to limit traffic in storage system 110. In the latter example, commands for the most likely predetermined paths may in some cases be sent in an earlier round and only if required for supplementation, commands for less likely predetermined paths may be sent in later round(s). This latter example may be appropriate, for instance, if time constraints for analyzing failure are less pressing than traffic limitations.

In the illustrated embodiments, indication obtainer 220 is configured to obtain indications of results in return for the input/output commands sent by generator 210. In some embodiments, as will be explained in more detail below with respect to FIG. 3, an indication sent in return may be related to the handling of the input/output command sent by generator 210 or to the handling of a previous similar input/command sent by host 190. In other embodiments, an indication of results sent in return necessarily relates to the handling of the input/output command sent by generator 210.

In some embodiments, no reply from an entity 120 may provide an (implicit) indication of failure result or alternatively of success result. In these embodiments, assuming for example that no response is an indication of failure, indication obtainer 220 obtains indications of success results by receiving such results from entities 120, optionally obtains some indications of failure results by receiving such results from entities 120, and obtains all or the rest of the indications of failure results by determining which entities 120 did not respond, for example in a predetermined period of time. In these embodiments, assuming for example that no response is an indication of success, indication obtainer 220 obtains indications of failure results by receiving such results from entities 120, optionally obtains some indications of success results by receiving such results from entities 120, and obtains all or the rest of the indications of success results by determining which entities 120 did not respond, for example in a predetermined period of time. This example may in some cases result in less traffic between entities 120 and controller 150 because it is assumed that there will be less failure results. However in this example, it is assumed that if an entity 120 fails and can therefore not respond, controller 150 will become aware of the failure of the entity through other reporting for example by another entity 120 or by a different element in system 100. In other embodiments indication receiver 220 receives from each entity an explicit response with indication of success or failure.

In some embodiments, indication obtainer 220 may obtain indications of failure results not in return for the commands sent by generator 210. For example, assume no response is an implicit failure indication. Further assume in this example that (receiving) entity 120 received a command from host 190 but was unable to perform the command, or performed the command and passed the command to another entity 120 but received from the other entity 120 a failure result, or there was no response from the other entity 120, for example within a predetermined period of time. In this example, receiving entity 120 may provide an indication of the failure result to indication obtainer 220. In some embodiments, additionally or alternatively, indication obtainer 220 may optionally obtain indications of success results not in return for the commands sent by generator 210. Continuing with the example, assume receiving entity 120 instead received a command from host 190, successfully performed one or more local actions, and optionally passed the command to another entity 120, getting from the other entity 120 a success result. In this example, receiving entity may provide an indication of the success result to indication obtainer 220.

In the illustrated embodiments, failure result indication detector 230 is configured to detect if there is at least one indication of failure result. In some embodiments, the detected failure result is necessarily a result obtained in return for a command sent by generator 210. In other embodiments, the detected failure result may or may not be a result obtained in return for a command sent by generator 210. For example the failure result may relate to a command originating from host 190. In various embodiments, detector 230 may check indications when obtained, or may check indications stored in memory.

In the illustrated embodiments, optional memory 240 is configured to store indications of results. Depending on the embodiment, the stored indications may relate to indications obtained in return for commands generated by generator 210 or may relate to both indications obtained in return and indications obtained for input/output commands originating with host(s) 190 which are not in return for the input/output commands sent by generator 210. Depending on the embodiment, the stored indications may be the same as the obtained indications (by indication obtainer 230) or may be in a different format, for example in order to facilitate analysis. Depending on the embodiment, all indications obtained by indication obtainer 230 may be stored in memory 240 (in the same or different format), only indications obtained by indication obtainer 230 after a failure result indication has been detected by failure result indication detector 230 may be stored in memory (in the same or different format), or only selective indications obtained by indication obtainer 230 after a failure result indication has been detected by failure result indication detector 230 may be stored in memory (in the same or different format). As an example of the latter, in some embodiments only failure result indications or only success result indications may be stored with the other implied by the omission, thereby conserving memory. In some embodiments, indications may be overwritten in memory 240 if no failure analysis is being performed on the indications or if the failure analysis has been completed on the indications. In some embodiments, memory 240 is sufficiently large to be able to at least store enough indications for analyzer 250 to perform an analysis.

In the illustrated embodiments, if detector 230 detects a failure result indication, analyzer 250 is configured to analyze at least some indications to determine a reason for the failure result indication detected by detector 230. In some embodiments, indications from one round of commands sent by generator 210, optionally in conjunction with (unrelated to the round) indications for commands generated by host 190 may be sufficient for analyzer 250 to perform the analysis. In these embodiments based on these indications, analyzer 250 determines which entity failed causing the result failure indication(s), determines that a plurality of failed entities (whose identities are unknown) caused the result failure indication(s), or determines that the analysis is inconclusive. In other embodiments, the analysis may also include a determination if the reason for the indication of failure result is a transient failure or an enduring failure. In these embodiments, analyzer 250 may perform the analysis on indications from a plurality of rounds of commands sent by generator 210, optionally in conjunction with (unrelated to the round) indications for commands generated by host 190. In some cases, if the analysis for all of the plurality of rounds provides the same reason for failure, namely the same failed entity or the failure of a plurality of entities, then the failure is considered enduring but if the analysis for all of the plurality of rounds does not provide the same reason of failure, then the failure is considered transient. In other cases, the failure is considered transient or enduring depending on the percentage of failures out of the total, the number of consecutive failures, whether the number of failures is above or below a predefined threshold, any other criteria, and/or a combination of any of the above. Moreover, in other embodiments, regardless of whether or not the analysis includes a determination of transient or enduring failure, the analysis may involve indications from a plurality of rounds optionally in conjunction with (unrelated to the round) indications for commands generated by host 190 due to other considerations. For example, if the analysis of a previous round was inconclusive, indications from other rounds may assist in determining the reason for failure, for instance in some cases if the different rounds include indications from different predetermined paths. In embodiments where the analysis involves indications from a plurality of rounds, the number of rounds whose indications are included in the analysis may be predefined, may be dependent on a predefined duration (for example the grace period or timeout discussed below), may be dependent on the stability or reliability of the implementation, may be dependent on the desired sample size, or may be dependent on a combination of any of the above.

In the illustrated embodiments, the analysis is performed on indications stored in memory 240. In some embodiments, analysis may be performed on indications while the indications are obtained and failure indication detected. In some of these embodiments, memory 240 may therefore be omitted.

In some embodiments, an input/output command may be a write command causing data to be written to a location in memory in an entity 120 which is reserved for this purpose. In some cases this written data may also be considered by analyzer 250 when determining a reason for a failure result indication while in other cases the written data may not be considered during the determination.

In the illustrated embodiments, optional timer 260 provides timing to controller 150. For example, in some embodiments, command generator 210 generates and sends rounds of commands at a predetermined rate whose timing is provided by timer 260. In some of these embodiments, it may be desirable that the time interval between rounds should be less than the shortest timeout, where the timeout is the predetermined time lag between sending the command and determining that the command failed due to lack of response. In some of these embodiments where analysis is performed on a plurality of rounds, it may be desirable that the time interval for a plurality of rounds be less than the shortest timeout. It is noted that the timeout may not always be of the same length. For instance, the length of the timeout for a command may in some cases vary depending on the length of the predetermined path that the command follows. In some cases, the reason for desiring the time interval to be less than the timeout is to increase the likelihood of detecting the reason for the indication of failure early enough to prevent a timeout. In one implementation, where the timeout is one second, the time interval between rounds or alternatively for a plurality of rounds may be set to be less than one second, but in other implementations the interval may be more or less, or may be undefined. In other embodiments, there may not be a predetermined rate for generating and sending commands.

In another example, in some embodiments, timer 260 may alternatively or additionally provide timing to define a time period corresponding to indications that are to be analyzed. In some of these embodiments, the time period relates to a grace period in which storage system 110 does not yet define a failure as enduring, and therefore during this period it is unknown whether a detected indication of failure points to an enduring or transient failure. Therefore in some of these embodiments the indications analyzed relate to a time period at least as long as the grace period, and perhaps in some cases, at least as long as twice the length of the grace period. For example if the grace period is 10 seconds then in these embodiments the time period would be at least as long as 10 seconds. In various embodiments, the time period may begin, for instance, with obtaining of the first indication of failure result, or, for instance, with the sending of the round of commands for which in return an indication of failure result was obtained, or at any other suitable point in time. In some embodiments, additionally or alternatively, the time period (corresponding to indications that are to be analyzed) may be dependent on the desired sample size and/or the stability/reliability of the implementation, where the time period may in some cases be set larger for a less stable/reliable implementation. Analyzer 250 may be led to analyze indications belonging to the relevant time period in various ways depending on the embodiment. In some embodiments where analysis is performed as the indications are obtained, timer 260 may indicate to analyzer 250 to start and stop the analysis. In some embodiments where analysis is performed on stored indications, there may be a time stamp on each stored indication so that analyzer 250 can recognize indications belonging to the relevant time period, whereas in other embodiments analyzer 250 may recognize indications belonging to the relevant time period by the positional order in memory 240. In other embodiments, additionally or alternatively, the overwriting or deleting in memory 240 may occur at the beginning of the time period so that only relevant indications for the time period are in memory 240 for analysis by analyzer 250.

In the illustrated embodiments, optional failure follow-up module 270 performs an action based on the reason determined by analyzer 250. For example, in some cases if the failure is transient then failure follow-up module may perform any of the following inter-alia: report transient failure, not take any action, continue monitoring to see if transient failure returns, initiate mitigating action, etc. In another example, if the identity of an entity 120 with enduring failure is detected, failure follow-up module 270 may perform any of the following inter-alia: report the identity of the failed entity 120, shutdown storage system 110, attempt to recover the failed entity 120, initiate any other mitigating action, etc. In another example, if enduring failure of a plurality of entities 120 is detected, failure follow-up module 270 may perform any of the following inter-alia: report the failure , shutdown storage system 110, initiate any other mitigating action, etc. Follow up is not limited to the above examples.

FIG. 3 is a block diagram illustration of a single entity 120 in storage system 110, according to some embodiments of the present invention. In the illustrated embodiments, entity 120 includes an input/output command receiver 310, a command handler 340, an indication returner 350, optionally an origin detector 320, optionally a command comparer 330, and optionally a memory 360. Each of modules 310, 320, 330, 340, 350 and/or 360 may be made up of any combination of software, hardware and/or firmware capable of performing the operations as defined and explained herein. In some embodiments, entity 120 may comprise fewer, more and/or different modules than illustrated in FIG. 3. In some embodiments, the functionality of entity 120 described herein may be divided differently among the modules shown in FIG. 3. In some embodiments, the functionality of entity 120 described herein may be divided into fewer, more and/or different modules than shown in FIG. 3. In some embodiments, entity 120 may include additional or less functionality than described herein. For example, in some cases entity 120 may include additional functionality unrelated to handling input/output commands and/or functionality related to the type of entity 120 (for instance the entity type may be: controller entity, storage entity, etc).

Command receiver 310 is configured to receive input/output commands. For example, depending on which entity comprises command receiver 310, command receiver 310 may receive commands from host(s) 190, from failure monitoring controller 150, and/or from an entity before on the predetermined path (for instance from an entity in a lower level of storage system 110 along a predetermined path). For example, referring back to FIG. 1C where entities are arranged on levels, entity A₁ 120₁₁ could receive commands from any of hosts H₁ 190₁ to H_{q} 190_{q} or from failure monitoring entity 150. In this figure, entity B₁ 120₂₁ could receive commands from any of entities 120 on the A level (e.g. from any of entities 120₁₁ to 120₁ₘ) or from failure monitoring entity 150. A command received by entity B₁ 120₂₁ from any of the entities 120 on the A level may have originated from any of the hosts H₁ 190₁ to H_{q} 190_{q} or from failure monitoring entity 150. Depending on the embodiment, command receiver 310 may be aware of all of the remaining entities on the predetermined path of the command, if any, or may be aware only of the next entity (or of a subset of the remaining entities) located on the predetermined path, if any.

Depending on the implementation, entity 190 may or may not differentiate between the processing of received commands originating from failure monitoring controller 150 and the processing of received commands originating from host(s) 190. Assuming there is no differentiation, in the illustrated embodiments command handler 340 is configured to necessarily handle a command originating from failure monitoring controller 150 in the same known fashion as a command originating from host 190 would be handled. For example, in some of these embodiments command handler 340 is configured to handle a command originating from failure monitoring controller 150 or from host 190 by performing one or more local actions, and if not the final entity on the predetermined path of the command then invoking a remote request to the next entity located on the predetermined path. Continuing with the example, if the entities are arranged on levels then command handler 340 is configured to pass the command to an entity at the next higher level (if any) on the predetermined path. Similarly, assuming there is no differentiation, in the illustrated embodiments indication returner 350 is configured to return an indication relating to a command originating from failure monitoring controller 150 (where in some cases not responding is a way of returning a result) in the same known fashion as an indication relating to a command originating from host 190. For example, in some of these embodiments, indication returner 350 is configured to return an indication of success or failure result to the particular host 190, particular entity 120, or failure monitoring controller 150 from which the command was received.

Assuming instead that there is differentiation in processing, then in the illustrated embodiments command handler 340 and indication returner 350 may in some cases handle a command and return an indication differently for a command originating from failure monitoring controller 150 than for a host-originating command. In these embodiments, origin detector 320 detects the origin of the command. Depending on the embodiment, the differentiation in processing may apply to any command originating from failure monitoring controller 150 or only to commands originating from failure monitoring controller 150 which were directly received by the current entity 120 from failure monitoring controller 150 (and not via one or more other entities 120). In the latter embodiment, differentiation in processing is not applied because it is assumed that the entity 120 which received the command from failure monitoring controller 150 would only have passed the command onto the next entity after determining that the command should be handled like a host-originating input/output command.

Assuming differentiation in processing, then in the illustrated embodiments origin detector 320 is configured to determine the origin of a received command. If the origin is not failure monitoring controller 150 (but for example the origin is host 190), origin detector 320 is configured to store the command in one or more storage segments of memory 360. Command handler 340 is configured to then handle the command in a known fashion (e.g. performing one or more local actions, and possibly invoking a remote request) and indication returner 350 is configured to return an indication of the result in the known fashion (e.g. success or failure, where in some cases not responding is a way of returning a result).

In some embodiments with differentiation in processing, if the origin of the command is failure monitoring controller 150 then the command is a candidate for comparing. Thus, command comparer 330 is configured to compare the received command with any input/output commands from host(s) 190 from a certain time frame, for example which were handled since the last command whose origin was failure monitoring controller 150. In alternative embodiments with differentiation in processing, origin detector 320 is further configured to determine if a command originating from failure monitoring controller 150 was received directly from failure monitoring controller 150 or via one or more other entities 120. In some of these alternative embodiments, if the origin is failure monitoring controller 150 but the command was received via one or more other entities 190, command handler 340 is configured to handle the command in a known fashion (e.g. performing one or more local actions, and possibly invoking a remote request), and indication returner 350 is configured to return an indication of the result (e.g. success or failure, where in some cases not responding is a way of returning a result) in a known fashion. However in these alternative embodiments, if the origin is failure monitoring controller 150 and the command was instead received directly from controller 150, then the command is a candidate for comparing. Thus command comparer 330 is configured to compare the received command with any input/output commands from host(s) 190 from a certain time frame, for example which were handled since the last command whose origin was failure monitoring controller 150.

In the illustrated embodiments it is assumed that the comparison is made to command(s) from host(s) 190 which were received or sent in a certain time frame. In these embodiments, memory 360 is configured to store command(s) from host(s) 190 which were received or sent in that certain time frame. For example, the time frame may be bound by the last command whose origin was failure monitoring controller 150. Depending on the embodiment in this example, the last command may have necessarily been from the previous round sent by failure monitoring controller 150, or the last command may have been the last controller-originating command received by command receiver 310 from any earlier round and not necessarily from the previous round (for example if rounds are sent selectively to entities 190). Continuing with the example, assuming that any commands originating with hosts 190 are overwritten/erased in memory 360 after handling or not handling a command originating from failure monitoring controller 150 (as will be explained further below), then memory 360 is configured to store only those commands originating from hosts 190 (if any), since the last command whose origin was failure monitoring controller 150. However in other embodiments, the certain time frame of commands from host(s) 190 which are subject to the comparison may be more limited or more expansive and therefore in some cases, memory 360 may be configured to store only commands which are more recent (if any), or may also be configured to store older commands (if any), respectively. For example, in one embodiment the certain time frame subject to comparison may be limited to the last received host-originating command or to the last received predefined number of commands from host(s) 190. In some embodiments, the storage segments in memory 360 are not limited to storing host-originating commands for comparison purposes but memory 360 may also include storage segments referred to by the input/output commands, and/or storage segments for other purposes.

In the illustrated embodiments, if command comparer 330 determines as a result of the comparison, that the received command is similar to a previously handled command originating from any host 190 (within a certain time frame), then command handler 340 is configured to not handle the received command in a usual fashion. For example, in some of these embodiments handler 340 is configured to not perform one or more local actions, and to not invoke a remote request to the next entity (if any) located on the predetermined path. Instead, in these embodiments indication returner 350 is configured to return an indication of the result of a similar previously handled host-originating command to the sender (e.g. entity 120 earlier on the predetermined path or e.g. failure monitoring controller 150) of the command. The returned indication may be explicit or may be implicit through a non-response. In some cases, not handling the received similar command may be advantageous in that traffic between entities 120 in storage system 110 and/or tasks performed by entity 120 may sometimes be lessened.

In the illustrated embodiments, if command comparer 330 instead determines as a result of the comparison, that the received command is different than any previously handled commands originating from any host 190 (within a certain time frame), then command handler 340 is configured to handle the received command in a usual fashion. For example, in some of these embodiments handler 340 is configured to perform one or more local actions, and if not the final entity on the predetermined path of the command then handler 340 is configured to invoke a remote request to the next entity located on the predetermined path. Continuing with the example, if the entities are arranged on levels then command handler 340 is configured to pass the command to an entity at the next higher level (if any) on the predetermined path. In these embodiments, indication returner 350 is configured to return an indication of the result of the handled received command to the sender (e.g. entity 120 earlier on the predetermined path or e.g. failure monitoring controller 150) of the command. In one embodiment, returned indications may be required to be explicit, whereas in another embodiment indications may be explicit or may be implied through a non-response.

The definition of similar commands is not limited by the invention. For example, in some embodiments, similar commands are commands whose performance involves the same activity (e.g. write, read) and which follow the same predetermined path. As another example, in some embodiments, similar commands are commands whose performance does not necessarily involve the same activity (e.g. write, read), but which follow the same predetermined path. In some embodiments, when determining if two commands follow the same predetermined path, the same predetermined path necessarily includes the same entities 120 from first receipt by storage system 110 of the command from host 190 or from failure monitoring controller 150. In other embodiments, when determining if two commands follow the same predetermined path, the same predetermined path means that the path of both commands subsequent to entity 120 which is performing the comparison includes the same entities 120 (i.e. the path prior to comparing entity 120 is inconsequential). In other embodiments, the same predetermined path may be defined otherwise. Different commands are defined as commands which are not similar.

In some embodiments with no processing differentiation, origin detector 320 and command comparer 330 may be omitted from entity 120. In some embodiments with no processing differentiation and in which memory is otherwise not necessary, memory 360 may be omitted.

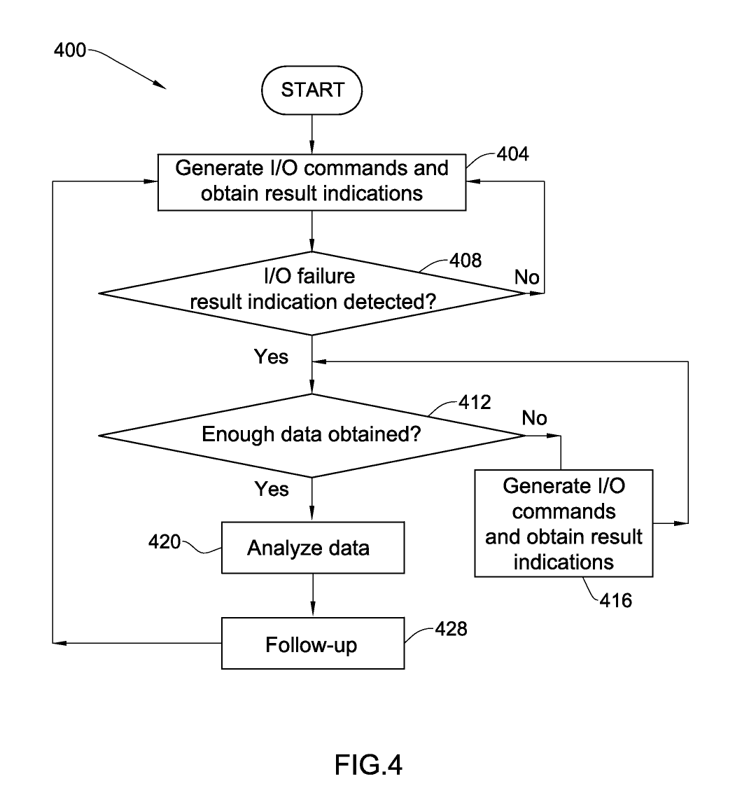

FIG. 4 is a flowchart illustration of a method 400 for monitoring failure in a storage system, according to some embodiments of the invention. In some embodiments, method 400 is performed by failure monitoring controller 150, and therefore the reader is referred to the description of FIG. 2 for additional illustration. In some cases, method 400 may include fewer, more and/or different stages than illustrated in FIG. 4, the stages may be executed in a different order than shown in FIG. 4, and/or stages that are illustrated as being executed sequentially may be executed in parallel.

In the illustrated embodiments, in stage 404, a round of commands are generated, for example by command generator 210, and sent to entities 120 in storage system 110 and indications of results are obtained in return, for example by indication obtainer 220. In some embodiments, the commands are generated at a predetermined rate and are therefore termed heartbeats due to their regularity. However in other embodiments, the commands may not be generated at a predetermined rate. Depending on the embodiment, the round of commands may be sent to all entities in storage system 110 or to selective entities. Depending on the embodiment, the round of commands may correspond to all predetermined paths or only to selective predetermined paths. Depending on the embodiment, commands in a round may or may not be sent simultaneously to receiving entities.

The indications obtained in return may be explicit or may be implicit from a non-response. In some embodiments, the indications obtained in return necessarily relate to handling of commands sent by generator 210, whereas in other embodiments the indications obtained in return may relate to handling of commands sent by generator 210 or to the handling of similar commands sent by host(s) 190.

In the illustrated embodiments in stage 408, it is determined, for example by failure result indication detector 230, if there is at least one indication of failure result. In some embodiments, the detected failure result is necessarily a result obtained in return for a command sent by generator 210. In other embodiments, where indications of failure results are also obtained not in return for commands sent by generator 210, the detected failure result may be a result obtained in return for a command sent by generator 210 or may be an obtained failure result relating to a host-originating command.

In the illustrated embodiments, in stage 412 it is determined, for example by analyzer 250 and/or timer 260, if enough data has been obtained for the analysis. Once sufficient data has been obtained, method 400 continues with stage 420. In some embodiment, indications returned for one round of commands are sufficient to perform the analysis. In some of these embodiments, the round considered is the round which included the command for which the failure indication result was returned, the round following the round which included the command for which the failure indication result was returned, or any other round depending on the implementation. In other of these embodiments where the detected failure result was obtained for another command and not in return for a command sent by generator 210 then the round considered may be the previous round before the detected failure result, the round following the detected failure result, the round closest in time to the detected failure result, or any other round depending on the implementation.

In some embodiments, indications returned for a plurality of rounds of commands are used in performing the analysis, for example in order to determine if a failure is transient or enduring, and/or for example in some cases if the different rounds include indications from different predetermined paths. In embodiments where the analysis involves indications from a plurality of rounds, the number of rounds whose indications are included in the analysis may be predefined, may be dependent on a predefined duration (for example the grace period or timeout discussed above), may be dependent on the stability or reliability of the implementation, may be dependent on the desired sample size, or may be dependent on a combination of any of the above.

If another round is required (no to stage 412), either because indications from a subsequent round are to be considered in the analysis or because indications from a plurality of rounds are to be considered in the analysis, then in stage 416 an additional round of commands are generated, for example by command generator 210, and sent to entities 120 in storage system 110. Indications of results are obtained in return, for example by indication obtainer 220. Depending on the embodiment, the additional sent round may be sent to the same entities 120 and correspond to the same predetermined paths as the previous round, or the additional sent round may possibly be sent to one or more different entities 120 and/or possibly correspond to one or more different predetermined paths. Examples of embodiments where the additional sent round may not necessarily be sent to the same entities 120 and/or not necessarily correspond to the same predetermined paths are now provided. In these examples, the commands sent in the additional round correspond only to predetermined paths for which indications of results are currently desired. For example, if one or more indications of failure result from the previous round(s) point to one or more predetermined paths as suspect, and/or point to one or more predetermined paths as definitely not suspect, then the entities to which commands in the additional round are sent may be selected based on the suspect/non-suspect paths. As another example, additionally or alternatively, assume enduring failure is defined as consistent failure and is interesting to the implementation, but transient failure is not interesting, and also assume that commands from previous round(s) corresponded to either indications of failures and successes, the additional round may only include those commands which corresponded to obtained indications of failures to see if the failure indications are enduring or not. As another example, additionally or alternatively, if a previous analysis needed supplementation, the additional sent round may be targeted to obtain the indications needed for supplementing the analysis.

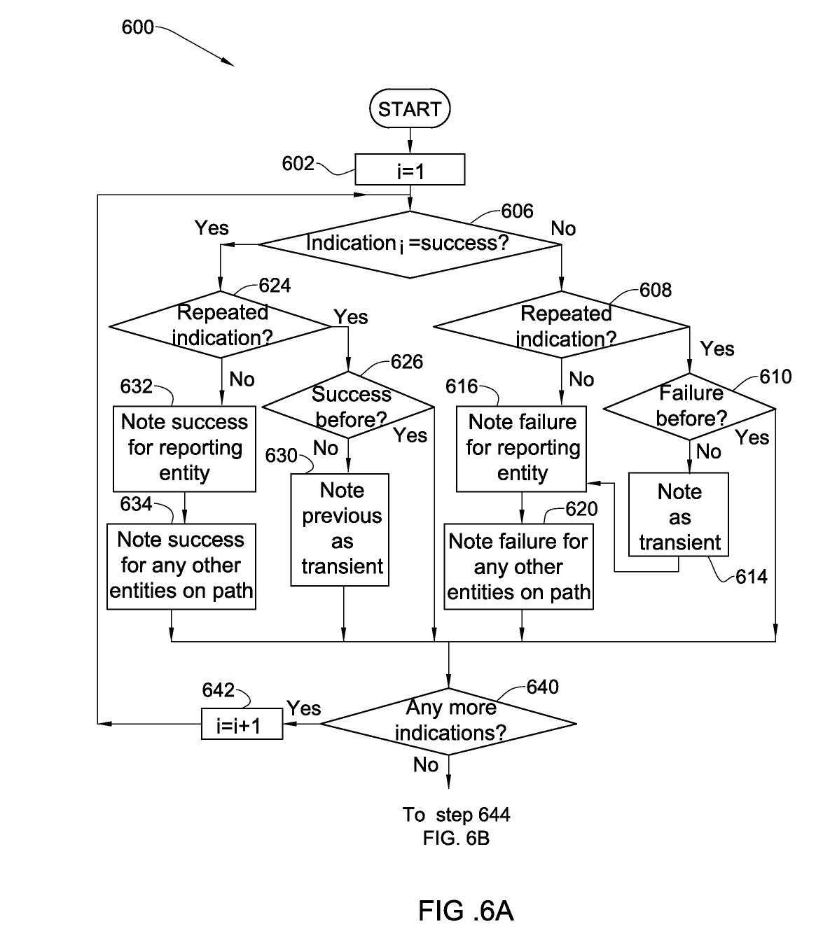

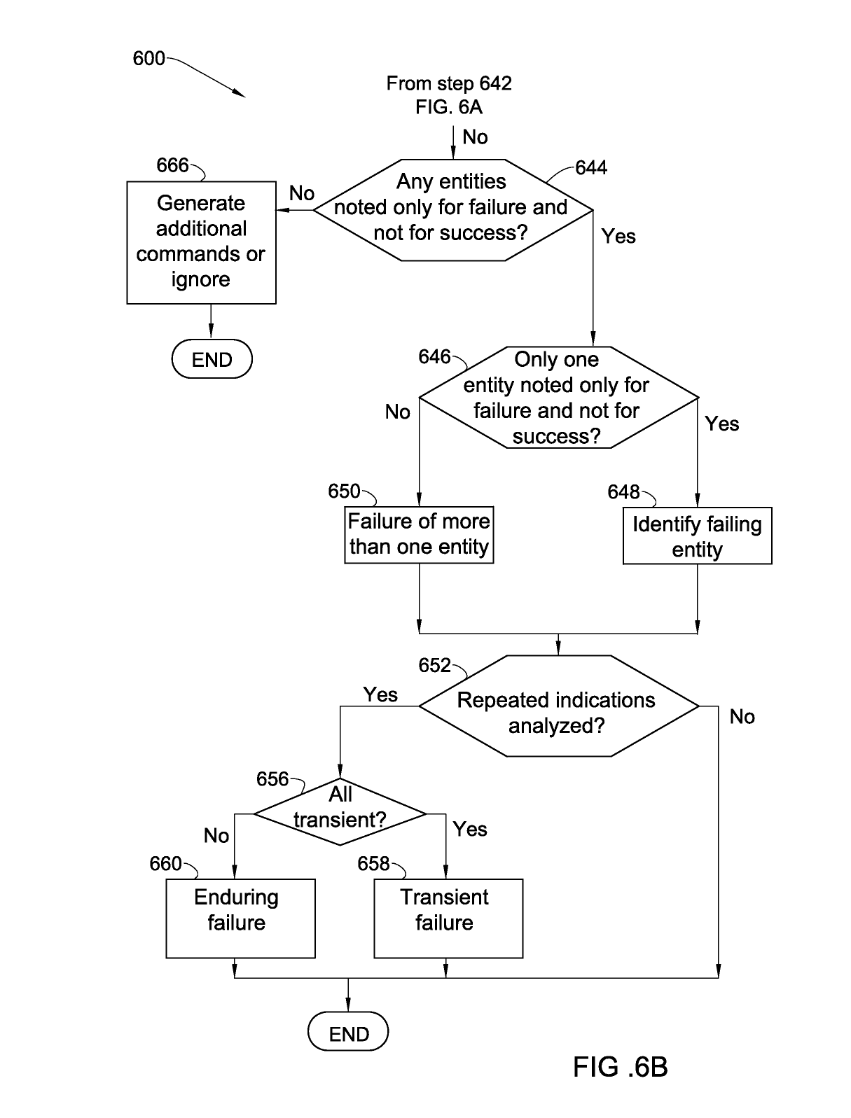

Once sufficient data has been obtained (yes to stage 412), an analysis is performed in stage 420, for example by analyzer 250. The type of analysis is not limited by the invention. In some embodiments, the analysis is passive in that the analysis is based on already obtained data and does not require the obtaining of additional data as the analysis progresses. However in other embodiments, the obtaining of additional data may be required to complete an analysis (for example by returning to stage 416 and then repeating stage 420). In some embodiments, the analysis, if conclusive, results in a determination of the reason for the indication of failure result received in stage 408. Possible reasons include the failure of one entity or the failure of multiple entities. In some of these embodiments the failure may be analyzed to determine if transient or enduring. For the sake of further illustration, the reader is referred below to FIG. 6 for one example of the analysis of stage 420.

In stage 428, there is optionally a follow up of the analysis, performed for example by follow-up module 270. The type of follow-up is not limited by the invention. Examples of follow-up include inter-alia: not taking any action, reporting, continuing to monitor, shutting down storage system 110, attempting to recover the failed entity, etc.

If the analysis is inconclusive then in some embodiments method 400 returns to stage 416 (after stage 420 or 428) in order to obtain additional indications to supplement the analysis, whereas in other embodiments, this returning to stage 416 does not occur even if the analysis was inconclusive. Assuming embodiments where method 400 returns to stage 416 after the analysis, in some cases the newly generated commands provide indications which were missing in the previous analysis.

In the illustrated embodiment, after stage 428 (and assuming embodiments where method 400 does not return to stage 416 after stage 428), method 400 begins again with stage 404.

Although in the illustrated embodiments, method 400 is shown beginning again after the analysis and optional follow-up are completed, in some embodiments command generation occurs at a steady rate, even if the analysis and follow up are not completed. In these embodiments, command generator 210 generates commands independently of the performance of stages 408 to 428, with the generation categorized as stage 416 or 404 depending on whether or not the generation occurs in the time range between the failure detection and the obtaining of sufficient data.

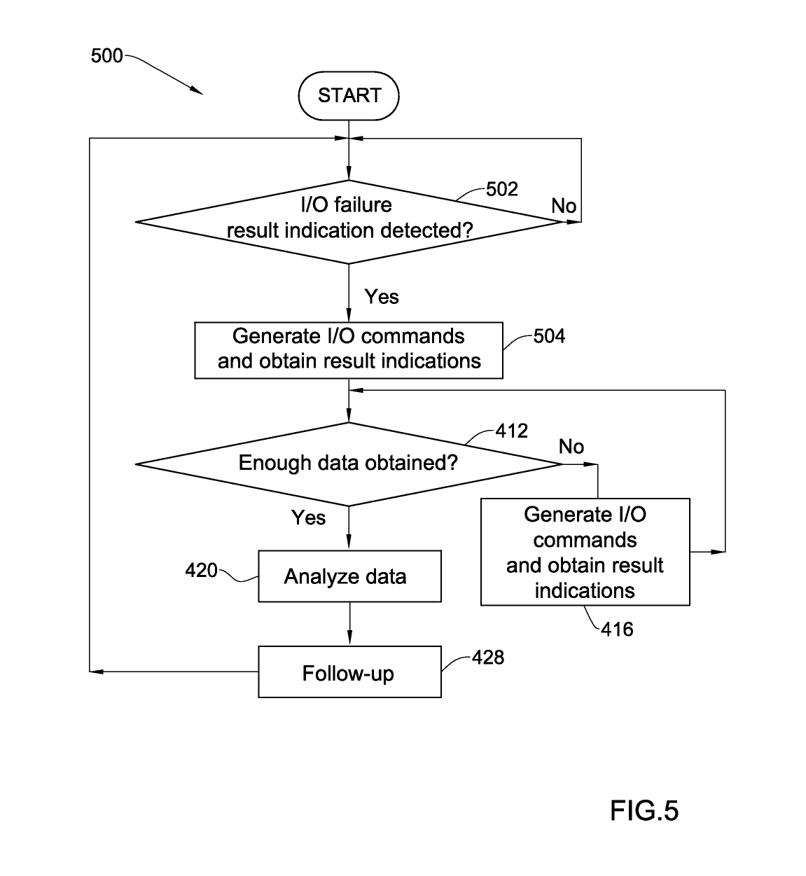

FIG. 5 is a flowchart illustration of a method 500 for monitoring failure in a storage system, according to some embodiments of the invention. In some embodiments, method 500 is performed by failure monitoring controller 150, and therefore the reader is referred to the description of FIG. 2 for additional illustration. In some cases, method 500 may include fewer, more and/or different stages than illustrated in FIG. 5, the stages may be executed in a different order than shown in FIG. 5, and/or stages that are illustrated as being executed sequentially may be executed in parallel. Similar steps to steps in method 400 are labeled with the same number.

In the illustrated embodiments, an indication of failure result is obtained relating to an input/output command generated by host(s) 190, for example by indication obtainer 220. For example, one or more failure indications relating to a command may have been sent by one or more entity/ies 120 on the predetermined path of the command and/or by generating host 190. The indication is detected to be an indication of failure result, for example by indication detector 230 (yes to stage 502).

In the illustrated embodiments in stage 504, a round of commands are then generated, for example by command generator 210, and sent to entities 120 in storage system 110 and indications of results are obtained in return, for example by indication obtainer 220. In some embodiments, the commands are generated at a predetermined rate and are therefore termed heartbeats due to their regularity. However in other embodiments, the commands may not be generated at a predetermined rate. Depending on the embodiment commands in a round may or may not be sent simultaneously to receiving entities. Depending on the embodiment, the round of commands may be sent to all entities in storage system 110 or to selective entities. Depending on the embodiment, the round of commands may correspond to all predetermined paths or only to selective predetermined paths. For example, in some embodiments the commands generated and/or the entities selected may be dependent on the indication result of failure obtained in stage 502, so that the generated commands correspond only to predetermined paths for which indications of results are currently desired. Continuing with the example, if the indication of failure result obtained in stage 502 relates to a suspect path then in one embodiment, the round of commands may exclude a command for this path because the failure result is already known. In this example, however in another embodiment, if the indication of failure result obtained in stage 502 relates to a suspect path including a plurality of entities 120 arranged on levels, then in one embodiment each of these plurality of entities may receive one or more generated commands, for instance with the entity at the highest level receiving one command, and entities at other levels receiving a number of command(s) equaling the number of predetermined paths leading to higher level entity/ies from that entity. Continuing with the example, assuming that indications of success results for input/output commands originating with host(s) 190 are alternatively or additionally received, these success results may allow a reduction in some cases to the number of generated commands. Still continuing with the example, in some embodiments, if an indication is a success result for a command corresponding to a particular predetermined path, then in some cases command generator 210 may not necessarily generate one or more commands corresponding to the same path or to sub-paths of that path.

In the illustrated embodiments, indications obtained in return for the generated commands may be explicit or may be implicit from a no-reply. In some embodiments, the indications obtained in return necessarily relate to handling of commands sent by generator 210, whereas in other embodiments the indications obtained in return may relate to handling of commands sent by generator 210 or to the handling of similar commands sent by host(s) 190.

In the illustrated embodiments, stages 412, 416 (if necessary), 420, and optionally 424 are then performed as described above with reference to FIG. 4. Method 500 is repeated beginning with stage 502 if and when an indication of failure result is next obtained relating to an input/output command generated by host(s) 190.

In some embodiments, in method 500, more rounds of commands than in method 400 may need to be generated in order for there to be enough data in stage 412.

FIG. 6 is a flowchart illustration of a method 600 for analyzing failure in a storage system, according to some embodiments of the invention. In some embodiments, method 600 is an example of stage 420. In some embodiments, method 600 is performed by analyzer 250 of failure monitoring controller 150 , and therefore the reader is referred to the description of FIG. 2 for additional illustration. In some cases, method 600 may include fewer, more and/or different stages than illustrated in FIG. 6, the stages may be executed in a different order than shown in FIG. 6, and/or stages that are illustrated as being executed sequentially may be executed in parallel.

In the illustrated embodiments, the analysis involves the following operations. In stage 602 a first indication is selected for analysis. Depending on the embodiment the order that indications are analyzed may be based on time of receipt of the indication, time transmission of the corresponding command, position in memory 240, random selection or any other selection method. The indication is analyzed beginning in stage 606. In stage 606 it is determined if the indication is an indication of success result or failure result. If the indication is an indication of failure result (no to stage 606) then in embodiments where the indication may possibly be a repeated indication, stage 608 is executed. An indication may possibly be repeated, for example if indications may correspond to commands from multiple rounds, from multiple hosts 190, from the same host(s) 190 multiple times, and/or may be for any other reason. In stage 608 it is determined whether the current indication corresponds to a repeated command. An indication may be considered a repeated indication based on various criteria which may vary depending on the embodiment. For example, in one embodiment a subsequent indication which was received from the same (reporting) entity 120 as a previous indication and which corresponds to a command that is supposed to follow the same predetermined path (from the beginning, or at least continuing from that entity) as the previous indication may be considered a repeated indication. In another embodiment, a subsequent indication which involves the same activity (e.g. read, write) as a previous indication, which was received from the same (reporting) entity 120 as a previous indication, and which corresponds to a command that is supposed to follow the same predetermined path (from the beginning, or at least continuing from the sending entity) as the previous indication may be considered a repeated indication. If the indication is a repeated indication (yes to stage 608) then in stage 610 it is determined if the indication was previously noted as a failure indication and is therefore consistent. If the previous indication was previously noted as a failure indication (yes to stage 610), then the method moves to the next indication (if any). If instead the indication was previously noted for success and is therefore not consistent (no to stage 610), then the failure indication is noted as transient in stage 614 for the reporting entity and any other entity on the predetermined path which the command follows (or the transient notation is retained if already noted so). The method then continues with stage 616. If the indication is not a repeated indication (no to stage 608), then the method skips from stage 608 to 616. In embodiments where there are no repeated indications, the method skips from stage 606 to 616.

In the illustrated embodiments in stage 616 the reporting entity 120 (i.e. the entity which explicitly or implicitly reported the indication of failure result) is noted in stage 616 for possible failure. If the reporting entity is not the only entity on a predetermined path which the command follows, then in stage 620 each other entity 120 on the predetermined path which the command is supposed to follow is also noted for possible failure. The method then moves to the next indication, if any.

In the illustrated embodiments, if the indication is instead an indication of success result (yes to stage 606) then in embodiments where the indication may possibly be a repeated indication, stage 624 is executed. An indication may possibly be repeated, for example if indications may correspond to commands from multiple rounds, from multiple hosts 190, from the same host(s) 190 multiple times, and/or may be for any other reason. In stage 624 it is determined if the current indication is a repeated indication. An indication may be considered a repeated indication based on various criteria which may vary depending on the embodiment as discussed above. If the indication is a repeated indication (yes to stage 624) then in stage 626 it is determined if the indication was previously noted for success and is therefore consistent. If the indication was previously noted for success (yes to stage 626), then the method moves to the next indication (if any). If instead the indication was previously noted for failure and is therefore not consistent (no to stage 626), then the (previous) failure indication is noted as transient in stage 628 for the reporting entity and any other entity on the predetermined path which the command follows (or the transient notation is retained if already noted so). The method then moves to the next indication, if any. If the indication is not a repeated indication (no to stage 624), then the method skips from stage 624 to 632. In embodiments where there are no repeated indications, the method skips from stage 606 to 632.

In the illustrated embodiments in stage 632 the reporting entity 120 (i.e. the entity which explicitly or implicitly reported the indication of success result) is noted in stage 616 for success. If the reporting entity is not the only entity on a predetermined path which the command follows, then in stage 634 each other entity 120 on the predetermined path which the command is supposed to follow is also noted for success. In some embodiments, stages 632 and 634 are omitted and it is assumed that any path which does not have the results explicitly noted is implicitly noted as successful. In these embodiments memory 240 may thus in some cases be conserved since the results of successful paths are not explicitly noted. In these embodiments, the stages below which refer to noted for success, refer to implicit notation in addition to or instead of explicit notation. The method then moves to the next indication, if any.

In the illustrated embodiments in stage 640, if there are more indications to be analyzed (yes to stage 640) then the method reiterates for the next indication (stage 642) beginning with stage 606. In some embodiments, only indications from one round are analyzed, whereas in other embodiments indications from multiple rounds of commands generated by generator 210 are analyzed. The additional rounds may supplement the earlier rounds, for example by providing indication(s) relating to at least one different reporting entity and/or different predetermined path than originally noted, and/or by demonstrating whether or not the notations relating to one or more entities 120 change over time, etc. In some embodiments, the indications analyzed relate to a time period at least as long as the grace period, as described above. In some embodiments, only indications returned for commands generated by generator 210 are analyzed (where the returned indications can relate to the handling of the generated commands or similar commands of different origination). However in other embodiments, in addition to indications returned for commands generated by generator 210, other indications may be analyzed, for example indications for command originating from host(s) 190 which were not obtained in return for commands generated by command generator 210.

In the illustrated embodiments, assuming there are no more indications to be analyzed (no to stage 640), it is determined in stage 644 if there are any entities 120 which were noted only for possible failure and not for success for all analyzed indications involving the entities. If there are entities 120 which were noted only for possible failure and not for success for all analyzed indications involving the entities (yes to stage 644) then in stage 646, it is determined if only one entity 120 was noted only for possible failure and not for success. If yes to stage 646, then in stage 648, the reason for indication of failure is noted as relating to the failure of the one entity 120 which was noted only for possible failure and not success. If instead there was a plurality of entities noted only for possible failure and not for success (no to stage 646), then the reason for indication of failure is noted as failure of more than one entity in stage 650. In embodiments where there is no analysis of repeated indications (no to stage 652), method 600 ends after stage 648 or 650. Assuming embodiments where there may be repeated indications (yes to stage 652), it is understood, based on the discussion in the previous stages, that where there was at least one failure result for a repeated indication the result was noted as failure for that indication (and not success even if there were also success results for the repeated indication). It is also understood that in these embodiments if the repeated indication included both success results and failure results, the result was also noted as transient. Therefore in embodiments where there may be analysis of repeated indications it is determined in stage 656 if the notations for all of the indications involving the entity/ies were noted as transient. If yes (yes to stage 656), then the failure is declared a transient failure in stage 656. If not all the indications involving the entity/ies were noted as transient but at least one was persistent (no to stage 656), then the failure is declared enduring (stage 660).

Returning to the description of stage 644, in the illustrated embodiments if no entities were noted only for failure and not for success (no to stage 644) then the analysis to date is inconclusive and in various embodiments method 600 can proceed differently. For example, in some embodiments where it is assumed that not enough indications were obtained, then the analysis of stage 420 may be put on hold and the method may return to stage 416 with the generation and sending of additional commands. In this example, the additional indications may be used to supplement the previous analysis, for instance by repeating method 600 to analyze the additional indications. In another example, in some embodiments where it is assumed that sufficient indications were obtained, then the analysis of stage 420 may end without a conclusion and method 400 or 500 may wait for another failure result indication to be detected before beginning a new analysis in stage 420 (ignoring the previous analysis which ended inconclusively).

It should be evident that additional methods of analysis stage 420 may be performed and the invention is not bound by the operations described herein with respect to method 600.

For example, method 600 assumes that if there are both success and failure results for a repeated indication, the failure was considered transient, however in other embodiments a failure may be defined as transient or enduring based on other criteria. Continuing with the example, in one embodiment transient or enduring failure may be determined based on a statistical test, where enduring failure would require a percentage of failure results out of a total number of results for a repeated indication to be above a predefined percentage floor (for instance 50%). Continuing with the example, in another embodiment, enduring failure would require at least a predefined number of consecutive failure results for a repeated indication. Continuing with the example, in another embodiment, enduring failure would require that the number of failure results for a repeated indication exceed a predefined threshold. Continuing with the example, in another embodiment, enduring failure would require that at least a certain number of failure results for a repeated indication occurred among the last predefined number of rounds. Continuing with the example, in other embodiments, enduring failure would require a combination of the above. For instance in one of these other embodiments, enduring failure would require that the number of failure results exceed a predetermined threshold and that at least a certain number of these failure results occurred in the last predefined number of rounds.

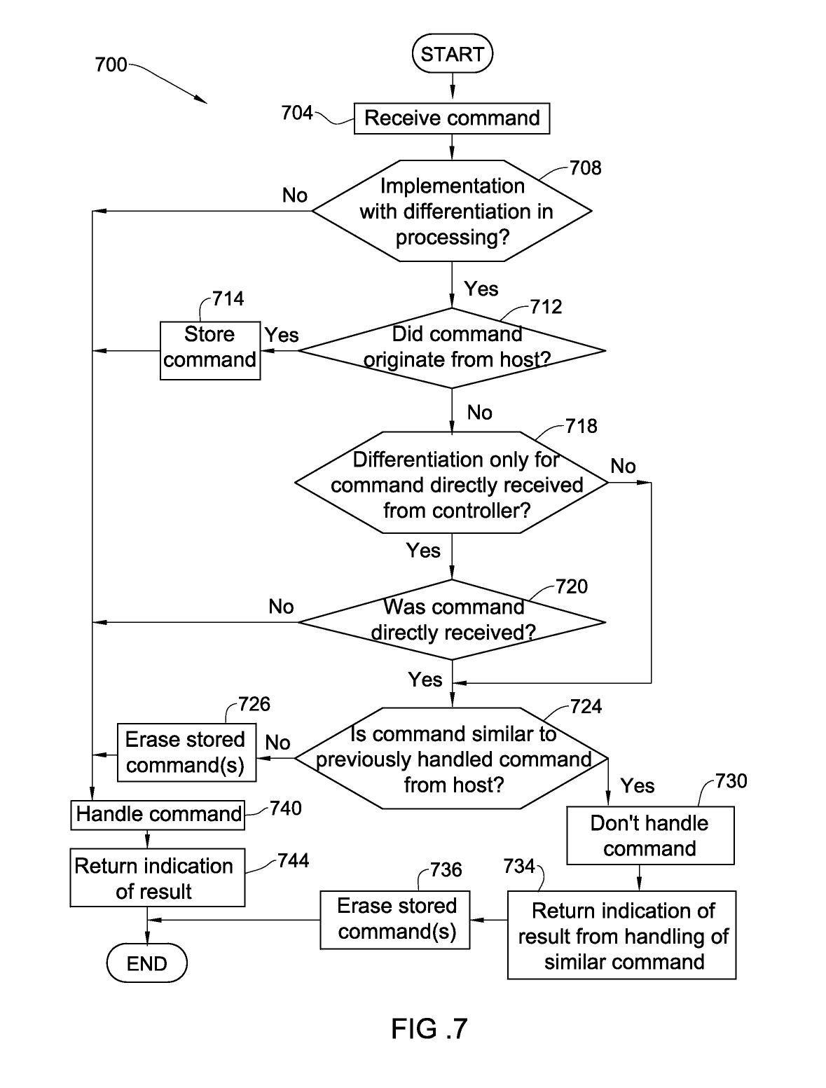

FIG. 7 is a flowchart illustration of a method 700 for handling input/output commands, according to some embodiments of the invention. In some embodiments, method 700 is performed by an entity 120, and therefore the reader is referred to the description of FIG. 3 for additional illustration. In some cases, method 700 may include fewer, more and/or different stages than illustrated in FIG. 7, the stages may be executed in a different order than shown in FIG. 7, and/or stages that are illustrated as being executed sequentially may be executed in parallel.

In the illustrated embodiments in stage 704, an input/output command is received from another entity 120, a host 190, or failure monitoring controller 150 for example by command receiver 310. Entity 120 may be aware of all remaining entities 120 located on the predetermined path, if any, or only of the next entity 120 (or of a subset of the remaining entities) located on the predetermined path, if any.

In the illustrated embodiments in stage 708 it is determined whether or not for the particular implementation there is differentiation in the processing of commands originating from host(s) 190 versus at least some of the commands originating from failure monitoring controller 150. If there is no differentiation (no to stage 708) then method 700 jumps to stage 740 (described below).

In the illustrated embodiments, if instead there is differentiation (yes to stage 708), then it is determined whether or not the command originated at host 190 (stage 712), for example by origin detector 320. If the command originated at host 190 (yes to stage 712), then the command is stored in stage 714, for example until the end of a certain time frame in memory 360, and method 700 jumps to stage 740 (described below). See discussion above with reference to FIG. 3 relating to some possibilities for a certain time frame.

In the illustrated embodiments, if the command originated instead with the failure monitoring controller 150 (no to stage 712), then in stage 718 it is determined whether for the particular implementation the differentiation in processing applies only to commands directly received by the current entity 120 from failure monitoring controller 150 or applies to all commands originating from failure monitoring controller 150, including those directly received and those received via other entities 120.

In the illustrated embodiments, if differentiation in processing applies only to commands directly received (yes to stage 718), and it is determined that the command was not directly received (no to stage 720), then the command is not a candidate for comparing and method 700 jumps to stage 740. If on the other hand differentiation in processing applies only to commands directly received (yes to stage 718) and the command was directly received (yes to stage 720), or if alternatively differentiation in processing applies to all commands originating from failure monitoring controller 150 (no to stage 718), then the command is a candidate for comparing and method 700 continues with stage 724. For example, origin detector 320 may determine if the command was directly received.

In the illustrated embodiments, in stage 724, the command is compared to previously handled commands from host 190 from a certain time frame, for example by command comparer 330. If in stage 724 it is determined that the command is not similar to any previously handled command from host 190 from a certain time frame (no to stage 724), then optionally and assuming the time frame ends with the current command, any stored commands originating from hosts 190 are removed from memory 360 in stage 726 and method 700 continues with stage 740. In some cases, stage 726 may be omitted, for example if the end of the certain time frame is independent of the current command.

In the illustrated embodiments, if instead in stage 724 it is determined that the command is similar to any previously handled command from host 190 from a certain time frame (yes to stage 724), then in stage 730 handling of the command is ignored, for example by command handler 340. In stage 734, an indication of the result of the similar command is returned to the sender of the command, for example by indication returner 350 (where the returned indication may be explicit or implicit). In optional stage 736 and assuming the time frame ends with the current command, any stored commands originating from hosts 190 are removed from memory 360. In some cases, stage 736 may be omitted, for example if the end of the certain time frame is independent of the current command. Method 700 then ends.

In the illustrated embodiments, in stage 740 (for example, following a no in stage 708, a no in stage 712, stage 714, a no in stage 720, a no in stage 724, and/or stage 726, etc), the command is handled in a usual fashion for example by command handler 340. For example usual fashion handling can include performing one or more local actions, and if not the final entity on the predetermined path of the command then invoking a remote request to the next entity located on the predetermined path. In stage 744, the indication of result of handling the command is sent back to the sender, for example by returner 350 (where the returned indication may be explicit or implicit). Method 700 then ends.

FIG. 8 shows an example of a system 100_{D} including one or more hosts 190 and a storage system 110, according to some embodiments of the invention. In the illustrated embodiments, storage system 110_{D} includes failure monitoring controller 150 and six entities 120, where entities F₁ 120₁₁ and F₂ 120₁₂ are controller entities, entities P₁ 120₂₁ and P₂ 120₂₂ are primary storage entities, and entities S₁ 120₃₁ and S₂ 120₃₂ are secondary storage entities. For example, in one embodiment controller entities may be configured to receive commands from host(s) 190 and/or map logical addresses to physical addresses, primary storage entities may be configured to store data in accordance with a write command, and secondary storage entities may be configured to store a copy of the data of the write command or data which enables recovery of the data of a write command. In the illustration, system 100_{D} includes at least four hosts, but in other embodiments, system 100_{D} may include fewer hosts or even only one host.

It is noted that not all possible paths between entities are predetermined paths in FIG. 8. Lines between entities in FIG. 8 show the predetermined paths. (For example there is no predetermined path that includes both P₂ 120₂₂ and S₁ 120₃₁ and therefore no connecting line). In the illustrated embodiments, predetermined paths starting with F₁ include: 1) F₁ 120₁₁ to P₁ 120₂₁ to S₁ 120₃₁ and 2) F₁ 120₁₁ to P₂ 120₂₂ to S₂ 120₃₂. Predetermined path starting with F₂ include 1) F₂ 120₁₂ to P₂ 120₂₂ to S₂ 120₃₂, and 2) F₂ 120₁₂ to P₁ 120₂₁ to S₁ 120₃₁. Predetermined path starting with P₁ includes: P₁ 120₂₁ to S₁ 120₃₁. Predetermined path starting with P₂ includes: P₂ 120₂₂ to S₂ 120₃₂. Predetermined path starting with S₁ includes: S₁ 120₃₁. Predetermined path starting with S₂ includes S₂ 120₃₂. Therefore in the illustrated example, if all predetermined paths are to be monitored, it is assumed that a round of at least eight input/output commands (equal to the number of predetermined paths) are generated by failure monitoring controller 150, for example on a routine basis to monitor system 110, or for example after receiving at least one failure indication for an input/output command generated by host(s) 190.

It is assumed in the example illustrated in FIG. 8 that P₁ 120₂₁ has failed. Due to the failure, it is expected that any command which follows a predetermined path including P₁ 120₂₁ will correspond to a failure result indication, whereas any command which follows a predetermined path excluding P₁ 120₂₁ will correspond to a success result indication. For example, one or more failure indications may be detected in return for input/output command(s) sent by failure monitoring controller 150, for instance as in method 400. In another example, one or more failure indications may additionally or alternatively be detected for an input/output command generated by host(s) 190, for instance as in method 500.

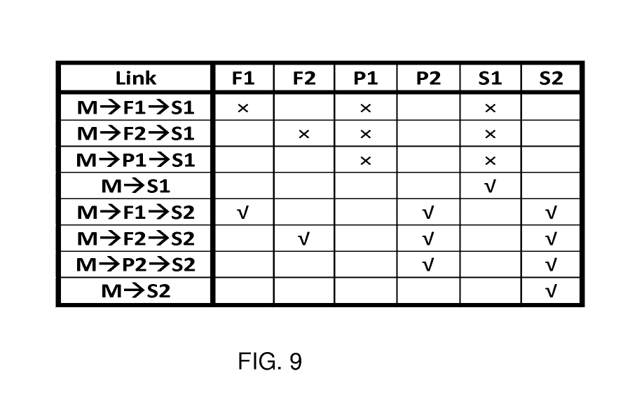

Refer to FIG. 9 which illustrates an analysis chart for detection of the failure in this example. Each row represents one of the input/output commands generated by failure monitoring controller 150 and each column represents an entity 120 in storage system 110. “M” represents failure monitoring controller 150. Looking at the first row corresponding to the predetermined path F₁ 120₁₁ to P₁ 120₂₁ to S₁120₃₁, because P₁120₂₁ has failed, an indication of failure result is returned for the command by F₁ 120₁₁ to failure monitoring controller 150. Therefore all the entities on this path, namely F₁120₁₁, P₁ 120₂₁ and S₁ 120₃₁ are noted for possible failure, for example with an “x”. Entries for non-participating entities (i.e. not on the path) for example are left blank. Referring to the second row corresponding to the predetermined path F₂ 120₁₂ to P₁ 120₂₁ to S₁ 120₃₁, because P₁ 120₂₁ has failed, an indication of failure result is returned for the command by F₂ 120₁₂ to failure monitoring controller 150. Therefore all the entities on this path, namely F₂120₁₂, P₁ 120₂₁ and S₁ 120₃₁ are noted for possible failure, for example with an “x”. Entries for non-participating entities (i.e. not on the path) for example are left blank. In the third row corresponding to predetermined path P₁ 120₂₁ to S₁ 120₃₁, because P₁ 120₂₁ has failed, an indication of failure result is returned by P₁ 120₂ to failure monitoring controller 150. Therefore both entities on this path, namely P₁ 120₂₁ and S₁ 120₃₁ are noted for possible failure, for example with an “x”. Entries for non-participating entities (i.e. not on the path) for example are left blank. In the fourth row corresponding to the predetermined path of S₁ 120₃₁ an indication of success is returned for the command by S₁ 120₃₁ to failure monitoring controller 150 and therefore S₁ 120₃₁ is noted for the success, for example with a “✓”, and the entries for the non-participating entities are for example left blank. Looking to the fifth row corresponding to the predetermined path F₁ 120₁₁ to P₂ 120₂₂ to S₂ 120₃₂ , an indication of success result is returned for the command by F₁ 120₁₁ to failure monitoring controller 150. Therefore all the entities on this path, namely F₁120₁₁, P₂ 120₂₂ and S₂ 120₃₂ are noted for the success, for example with a “✓”. Entries for non-participating entities (i.e. not on the path) are for example left blank. Referring to the sixth row corresponding to the predetermined path F₂ 120₁₂ to P₂ 120₂₂ to S₂ 120₃₂, an indication of success result is returned for the command from F₂ 120₁₂ to failure monitoring controller 150. Therefore all the entities on this path, namely F₂120₁₂, P₂ 120₂₂ and S₂ 120₃₂ are noted for the success, for example with a “✓”. Entries for non-participating entities (i.e. not on the path) for example are left blank. In the seventh row corresponding to the predetermined path P₂ 120₂₂ to S₂ 120₃₂, an indication of success result is returned for the command from P₂ 120₂₂ to failure monitoring controller 150. Therefore both entities on this path, namely P₂ 120₂₂ and S₂ 120₃₂ are noted for the success, for example with a “✓”. Entries for non-participating entities (i.e. not on the path) are for example left blank. In the eighth row corresponding to the predetermined path of S₂ 120₃₂, an indication of success is returned for the command from S₂ 120₃₂ to failure monitoring controller and therefore S₂ 120₃₂ is noted for the success, for example with a “✓”, and the entries for the non-participating entities are for example left blank. In an alternative embodiment, any path for which an indication of success was returned is omitted from the chart and the omission implies that the path was successful. Therefore in this alternative embodiment, the chart is reviewed for implicit success in addition to or instead of explicit success notation.

Looking at the notations on the chart of FIG. 9, the only column that has all “x”'s (failures), and no “✓”'s (successes) is the column of P₁ 120₂₁. Therefore it is concluded in this example that P₁ 120₂₁ has failed.

In some embodiments, more than one round of commands may be sent, and the returning indications noted in order to analyze whether the failure of P₁ is transient or enduring. For example, assuming that there are 6 rounds sent, then in some embodiments, if each of the indications for P₁ 120₂₁, namely in the first, second and third row is noted for success in at least one of the rounds, then the failure will be concluded to be transient. Continuing with the example, in these embodiments if instead at least one of the indications (e.g. in the first, second or third row) is consistently noted for failure in all of the rounds, then the failure will be concluded to be enduring.

In other embodiments, less than eight commands may be sent in a round. For example, if an indication of failure was received for an input/output command sent by host 190 along a certain path, then failure monitoring controller 150 may omit sending a command along this path and just note the entities for failure on this path. Continuing with the example, if a command originating from host 190 for the path F₂ 120₁₂ to S₁ 120₃₁ resulted in an indication of failure, then in this example, failure monitoring controller 150 omits sending a command for the F₂ 120₁₂ to S₁ 120₃₁ path and just notes failure for the entities on this path. As another example, if an indication of success was received for an input/output command sent by host 190 along a specific path, then failure monitoring controller 150 may omit sending a command along this path or along any (sub) paths which only include entities from this specific path, and just note the entities for success on this specific path and any sub-paths. Continuing with the example, if a command for the path F₂ 120₁₂ to S₁ 120₃₁ resulted in an indication of success, then in this example, failure monitoring controller 150 omits sending three commands: for the path from F₂ 120₁₂ to S₁ 120₃₁, for the path from P₁120₂₁ to S₁ 120₃₁ and for the path to S₁ 120₃₁ and just notes success for the entities for each of these three paths.

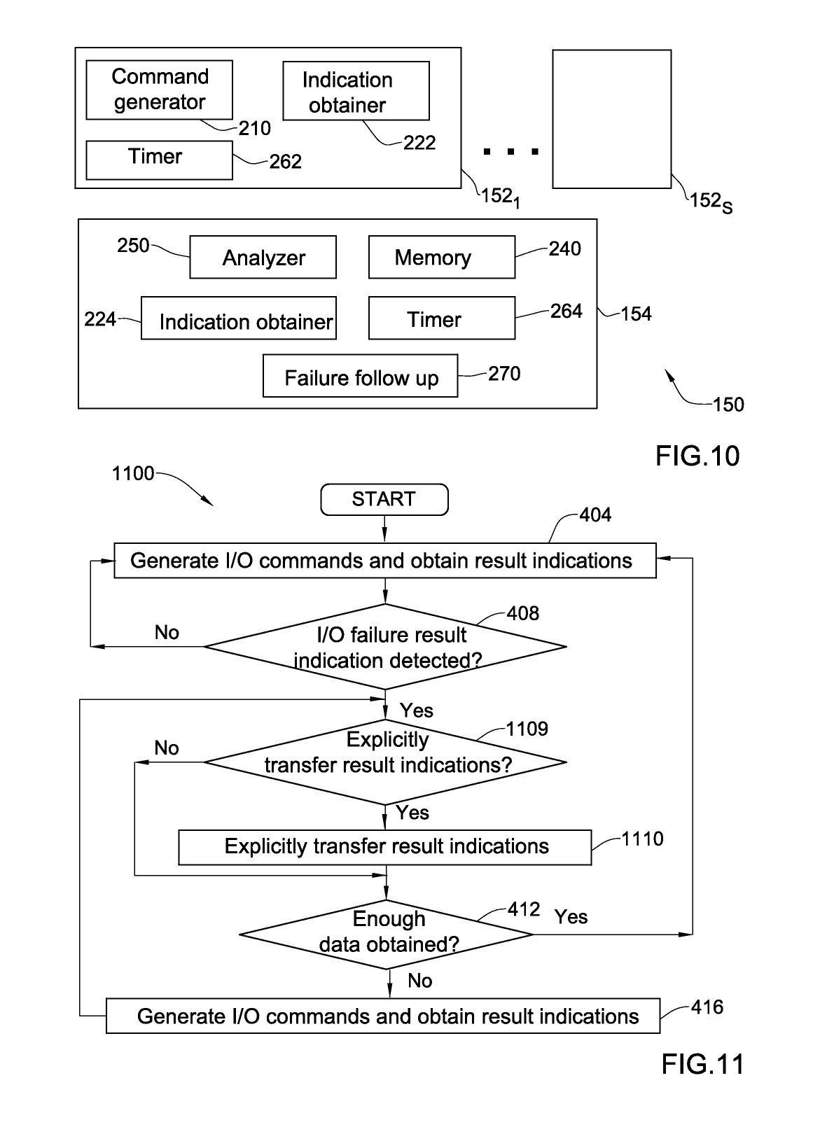

Above, unless explicitly stated otherwise, the single form of failure monitoring controller 150 was used to include both embodiments with one failure monitoring controller unit 150 and embodiments with a plurality of failure monitoring controller units 150. FIG. 10 illustrates some embodiments where failure monitoring controller 150 is physically divided into two or more units, including at least one controller type 152 and at least one controller type 154. Controller type 152 includes command generator 210, indication obtainer type 222 (which includes part of the functionality of indication obtainer 220), failure result indication detector 230, and optionally timer 262 (including part or all of functionality of timer 260). Depending on the embodiment, there may be one or more of controller type 152 (s≧1). For example, in some embodiments there may be one controller type 152 corresponding to all entities 150 in storage system 110, generating commands and obtaining result indications for any entity 120 in storage system 110. As another example in some embodiments, one of each controller type 152 may correspond to each entity 120, for example located at each entity 120 or in proximity to each entity 120. In this example each controller type 152 generates commands and obtains result indications for the corresponding entity. In some of these embodiments, each controller type 152 may be located in the same physical unit as the corresponding entity 120, and optionally at least some functionality of both may be merged, but for simplicity's sake the description assumes that the functionality of controller type 152 and the functionality of entity 120 are independent as if in separate physical units. As another example, in some embodiments, there may be a plurality of controllers type 152 with one of each controller type 152 corresponding to two or more entities 120, generating commands and obtaining result indications for the corresponding entities.

Controller type 154 includes indication obtainer type 224 (which includes part of the functionality of indication obtainer 220) analyzer 250, failure follow up module 270, optionally memory 240, and optionally timer 264 (including part or all of the functionality of timer 260). For simplicity of illustration, FIG. 10 shows only one controller type 154 in storage system 110 but in other embodiments there may be a plurality of controllers type 154.

As opposed to the case where controller 150 includes only one physical unit and the interface between modules is internal to the unit, in the embodiments illustrated in FIG. 10, the communication between controller type 152 and controller type 154 (for example between indication obtainer type 222 and indication obtainer type 224) is between respective units thereof.

FIG. 11 is a flowchart of a method 1100 performed by controller type 152, according to some embodiments of the invention. In some cases, method 1100 may include fewer, more and/or different stages than illustrated in FIG. 11, the stages may be executed in a different order than shown in FIG. 11, and/or stages that are illustrated as being executed sequentially may be executed in parallel.

In the illustrated embodiments, stages 404 and 408 are performed by controller type 152. For example, in stage 404 command generator 210 generates commands for any corresponding entity 120 and indication obtainer type 222 obtains indications from any corresponding entity 120. If no failure result indication is detected, for example by failure result indication detector 230 (no to stage 408) then method 1100 returns to stage 404. If instead failure result indication detector 230 detects a failure indication in stage 408, then in stage 1109 controller type 152, for example indication obtainer type 222, determines which if any of the obtained indications should be explicitly transferred to controller type 154, for example to indication obtainer type 224. Any indications for which the determination was that the indication should be explicitly transferred are explicitly transferred in stage 1110 from controller type 152 to controller type 154, for example from indication obtainer type 222 to indication obtainer type 224.

Traffic in storage system 110 may in some cases be reduced in the following embodiments. In one embodiment only selective indications are explicitly transferred from each entity 150 to corresponding controller type 152 thereof (for example only failure or successful results) Depending on the example of this embodiment, controller type may obtain any non-transferred results by recognizing a non-response as indicating the non-transferred result or may not attempt to obtain any non-transferred results. Subsequently controller type 152 only explicitly transfers selective indications to controller type 154, with controller type 154 obtaining any non-transferred results by recognizing a non-response as indicating the non-transferred result. The transferred selective indications can necessarily be those indication results explicitly received from entity 150 (for example if only failure results are explicitly received only failure results are transferred) and in this case it may be possible that controller type 152 does not obtain any results that are not explicitly received. Alternatively, the transferred selective indications may be other indications (for example if only successful results are explicitly received by controller type 152, only failure results may in any event be explicitly transferred to controller type 154). In another embodiment, all indications are explicitly transferred from each entity 150 to corresponding controller type 152 thereof but only selective indications are explicitly transferred to controller type 154 with controller type 154 obtaining any non-transferred results by recognizing a non-response as indicating the non-transferred result. In another embodiment, only selective indications are explicitly transferred from each entity 150 to corresponding controller type 152 thereof (for example only failure or successful results), with controller type 152 obtaining any non-transferred results by recognizing a non-response as indicating the non-transferred result but controller type 152 explicitly transfers all indications to controller type 154.

If there are less failure result indications than success result indications, then in some cases where only failure result indications are explicitly transferred, less traffic in storage system 110 may result than if success results are alternatively or additionally transferred.

In stage 412, controller type 152 determines if enough data has been obtained. The determination can be independently performed by controller type 152, for example using timer 262 or the determination can be based on information received from controller type 154 which may indicate to controller type 152 that enough data has been obtained. If not enough data has been obtained (no to stage 412), then stage 416 is performed and subsequently stages 1109 and 1110. Once enough data has been obtained (yes to stage 412), then method 1100 repeats. In some embodiments command generation occurs at a steady rate, with the generation categorized as stage 416 or 404 depending on whether or not the generation occurs in the time range between the failure detection and the obtaining of sufficient data.

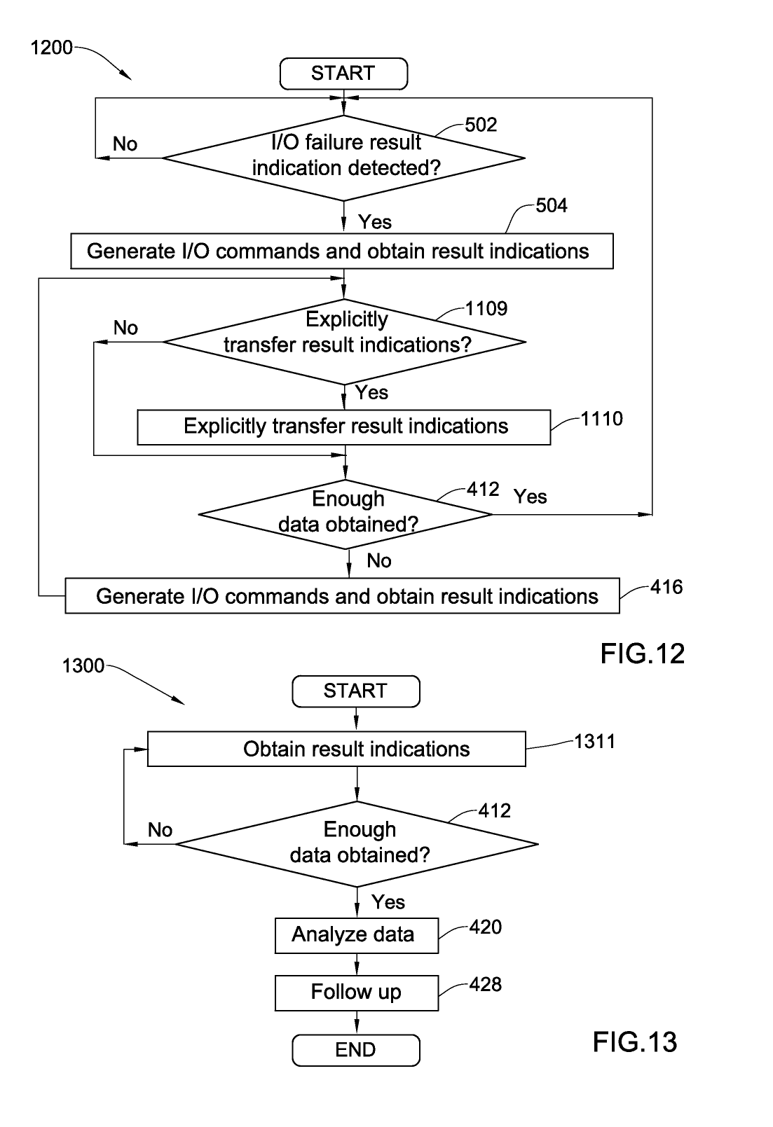

FIG. 12 is a flowchart of a method 1200 performed by controller type 152, according to some embodiments of the invention. In some cases, method 1200 may include fewer, more and/or different stages than illustrated in FIG. 12, the stages may be executed in a different order than shown in FIG. 12, and/or stages that are illustrated as being executed sequentially may be executed in parallel.

In stage 502 failure result indication detector 230 detects a failure. Therefore command generator 210 generates commands for any corresponding entity 120 and indication obtainer type 222 obtains indications from any corresponding entity 120. Stage 1109, 1110, 412 and 416 are subsequently performed as described above, except that if there is sufficient data (yes to stage 412) then method 1200 instead repeats. In some embodiments, traffic may be reduced as described above with reference to FIG. 11.

FIG. 13 is a flowchart of a method 1300 performed by controller type 154. In stage 1311, controller type 154, for example indication obtainer type 224, obtains result indications from controller type 152. The result indications may be explicitly received or may be implicit from a non-response. Stage 412 is then performed by controller type 154, for example analyzer 250 and/or timer 264 determine if there is sufficient data. In some embodiments, the result of the determination is transferred back to controller type 152 whereas in other embodiments the result of the determination is not transferred back. If not enough data has been obtained (no to stage 412) then more is obtained by reiterating to stage 1311. Once sufficient data has been obtained (yes to stage 412) then stage 420 is performed, for example by analyzer 250 and follow up is performed in stage 428, for example by failure follow up module 270.

The different methods, processes and flow charts discussed above—and the variations and discussed implementations thereof—may also be implemented as corresponding computer readable codes, each of which may be embodied in one or more computer readable mediums. Thus, for example, a computer readable medium is disclosed having a first computer readable code embodied therein for failure monitoring in a storage system, the first computer readable code including instructions for: (a) sending input/output commands to a plurality of entities in a storage system, and obtaining indications of results in return; and (b) if there is at least one indication of failure result detected, then analyzing at least said obtained indications of results in order to determine a reason for said detected indication of failure result.

In another example, a second computer readable medium is also disclosed, having a second computer readable code embodied therein for handling input/output commands in a storage system, the second computer readable code including instructions for: (a) receiving an input/output command; (b) detecting that said input output command originates from a failure monitoring controller and is a candidate for comparing; (c) comparing said detected command with at least one previously handled command originating from a host to determine if similar or different; (d) handling said detected command if different, or not handling said detected command if similar; and (e) explicitly or implicitly returning an indication of result of said similar previously handled command originating from said host if similar, or explicitly or implicitly returning an indication of result of said handled detected command if different.

It will also be understood that in some embodiments the system or part of the system according to the invention may be a suitably programmed computer. Likewise, some embodiments of the invention contemplate a computer program being readable by a computer for executing a method of the invention. Some embodiments of the invention further contemplate a machine-readable memory tangibly embodying a program of instructions executable by the machine for executing a method of the invention.

While certain features of the invention have been illustrated and described herein, many modifications, substitutions, changes, and equivalents will occur to those skilled in the art. It is therefore to be understood that the appended claims are intended to cover all such modifications and changes as fall within the true scope of the invention.

What is claimed is:

1. A method of failure monitoring in a storage system, comprising:
sending input/output commands to a plurality of entities in a storage system, and obtaining indications of results in return; and
if there is at least one indication of failure result detected, then analyzing at least said obtained indications of results in order to determine a reason for said detected indication of failure result.

2. The method of claim 1, wherein said input/output commands correspond to each predetermined path in said storage system.

3. The method of claim 1, wherein said input/output commands correspond to each predetermined path in said storage system for which indications of results are currently desired.

4. The method of claim 1, further comprising:
obtaining at least one indication of failure result which is not in return for said sent input/output commands but is related to at least one other input/output command, wherein said analyzed obtained indications includes said at least one obtained indication of failure result related to said at least one other input/output command.

5. The method of claim 4, wherein said sending occurs after obtaining an indication of failure result relating to another input/output command.

6. The method of claim 1, wherein said sending occurs independently of obtaining of any indication of failure result.

7. The method of claim 1, wherein an indication of a success result or alternatively of a failure result is obtained when no response is received.

8. The method of claim 1, wherein said detected indication of failure result was obtained not in return for said sent input/output commands but is related to another input/output command.

9. The method of claim 1, wherein said detected indication of failure result was obtained in return for a sent input/output command.

10. The method of claim 1, wherein said analyzing includes: analyzing indications of results corresponding to a predefined number of rounds.

11. The method of claim 1, wherein said analyzing includes: analyzing indications of results corresponding to a period of time which is at least equal to a grace period in which a failure would not yet be defined as enduring.

12. The method of claim 1, wherein input/output commands are sent at a higher rate than a reciprocal of shortest timeout of said system.

13. The method of claim 1, wherein said obtaining in return includes:
obtaining in return an indication of a result relating to handling of a previous input/output command of different origin instead of an indication of a result for handling one of said sent input/output commands.

14. The method of claim 1, further comprising taking action based on said reason.

15. The method of claim 1, wherein said multiple entities are on a plurality of levels in said storage system.

16. The method of claim 1, wherein said analyzing includes:
for each obtained indication of failure, adding or retaining failure notation for reporting entity and for any other entity on a predetermined path for said corresponding command;
for each obtained indication of success which is not a repeated indication, adding explicit success notation for reporting entity and for any other entity on a predetermined path for said corresponding command or implicitly noting success by omission;
determining if there are any entities noted only for failure and not for success;
if there is only one entity noted only for failure and not for success, then identifying failure of said entity as reason for said indication of failure; and
if there is more than one entity noted only for failure and not for success, then deciding that reason for said indication of failure is failure of more than one entity.

17. The method of claim 16, wherein said analyzing further includes: determining whether or not failure of said entity or entities is transient or enduring.

18. The method of claim 16, wherein said analyzing further includes:
if there is no entity noted only for failure and not for success, then determining that said reason is inconclusive.

19. A storage system comprising:
a failure monitoring controller including:
a command generator for generating and sending input/output commands to entities in said storage system;
an indication obtainer for obtaining indications of results in return for said sent input/output commands,
a failure result indication detector for detecting if there is at least one indication of failure result;
and an analyzer for analyzing indications of results, if at least one indication of failure result has been detected, in order to determine a reason for said detected indication of failure result.

20. The system of claim 19, further comprising: at least two entities.

21. The system of claim 20, wherein said system includes at least one predetermined path for transferring input/output commands among said at least two entities.

22. The system of claim 20, wherein an entity which receives an input/output command from said failure monitoring controller is configured to provide an indication of result to said failure monitoring controller explicitly, or implicitly by non-response.

23. The system of claim 22, wherein said entity is configured to handle said input/output command and provide an indication of result of said handling explicitly, or implicitly by non-response.

24. The system of claim 23, wherein said entity is also configured to instead provide an indication of result of a previously received and handled similar input/output command not originating from said failure monitoring controller explicitly, or implicitly by non-response.

25. The system of claim 19, wherein said controller further includes:
a timer for providing timing to said controller.

26. The system of claim 19, wherein said controller further includes:
a memory for storing indications of results.

27. The system of claim 19, wherein said controller further includes:
a failure follow up module for performing an action based on said reason.

28. The system of claim 20, wherein said failure monitoring controller is physically divided into two or more units.

29. The system of claim 28, wherein said physically divided failure monitoring controller includes a plurality of at least one selected from a group comprising: command generators, indication obtainers, failure result indication detectors, and analyzers.

30. An entity in a storage system comprising:
a command receiver for receiving input/output commands originating from a host, and for receiving input/output commands originating from a failure monitoring controller;
an origin detector for detecting that a received command originates from a failure monitoring controller and is a candidate for comparing;
a command comparer for comparing said detected command with at least one previously handled command originating from a host to determine if similar or different;
a command handler for handling said detected command if different, or for not handling said detected command if similar; and
an indication returner for explicitly or implicitly returning an indication of result of said similar previously handled command originating from said host if similar, or for explicitly or implicitly returning an indication of result of said handled detected command if different.

31. The entity of claim 30, wherein said origin detector detects that said received command is a candidate, only if said command is received directly from said failure monitoring controller.

32. The entity of claim 30, wherein said origin detector detects that said received command is a candidate inherently because said command originates from said failure monitoring controller.

33. The entity of claim 30, further comprising:
memory for storing host-originating commands.

34. A method of handling input/output commands in a storage system comprising:
receiving an input/output command;
detecting that said input output command originates from a failure monitoring controller and is a candidate for comparing;
comparing said detected command with at least one previously handled command originating from a host to determine if similar or different;
handling said detected command if different, or not handling said detected command if similar; and
explicitly or implicitly returning an indication of result of said similar previously handled command originating from said host if similar, or explicitly or implicitly returning an indication of result of said handled detected command if different.
